(19) United States
(12) Patent Application Publication
(10) Pub. No.: US 2012/0257872 A1
(43) Pub. Date: Oct. 11, 2012

(54) INFORMATION PROCESSING APPARATUS, INFORMATION PROCESSING METHOD, AND PROGRAM

(75) Inventors: Takahiro Toyoda, Tokyo (JP); Noboru Murabayashi, Saitama (JP); Hideo Nagasaka, Kanagawa (JP); Nanami Miki, Tokyo (JP); Tomoyuki Hanai, Kanagawa (JP)

(73) Assignee: Sony Corporation, Tokyo (JP)

(21) Appl. No.: 13/431,468

(22) Filed: Mar. 27, 2012

(30) Foreign Application Priority Data
Apr. 6, 2011 (JP) 2011-084500

(51) Int. Cl. H04N 9/80; H04N 5/76

(52) U.S. Cl. 386/241; 386/295; 386/239; 386/E09.011; 386/E05.028

(57) ABSTRACT

An information processing apparatus includes: a recording and reproduction control unit that records content on a predetermined recording medium and that reads and reproduces content from the predetermined recording medium, wherein the recording and reproduction control unit transmits and records information necessary for reproducing deleted content to a different information processing apparatus when it is intended to delete the content as a deletion target recorded on the predetermined recording medium, and synthesizes and reproduces the deleted content on the basis of the information from the different information processing apparatus when it is instructed to reproduce the deleted content.

### FIELD

The present disclosure relates to an information processing apparatus, an information processing method, and a program, and more particularly, to an information processing apparatus, an information processing method, and a program which can reproduce content identical or similar to deleted content.

### BACKGROUND

Recently, recording and reproducing apparatuses capable of recording contents such as television broadcast programs have spread. Such recording and reproducing apparatuses can record a large number of contents on a recording medium. However, since the recording capacity of a recording medium is finite, a technique of deleting predetermined content out of contents recorded on a recording medium has been used as a general technique of guaranteeing free capacity of the recording medium (see JP-A-11-176096).

### SUMMARY

However, the content deleted to guarantee the free capacity of the recording medium cannot be reproduced later. Content deleted through a user's operation cannot be reproduced later.

It is therefore desirable to allow the reproducing of content identical or similar to deleted content.

An embodiment of the present disclosure is direced to an information processing apparatus including: a recording and reproduction control unit that records content on a predetermined recording medium and that reads and reproduces content from the predetermined recording medium, wherein the recording and reproduction control unit transmits and records information necessary for reproducing deleted content to a different information processing apparatus when it is intended to delete the content as a deletion target recorded on the predetermined recording medium, and synthesizes and reproduces the deleted content on the basis of the information from the different information processing apparatus when it is instructed to reproduce the deleted content.

The recording and reproduction control unit may perform a compressing and encoding process on the content as a deletion target, may transmit and record the resultant compressed and encoded content to the different information processing apparatus, and may read, decompress, decode, and reproduce the content as a deletion target recorded in the different information processing apparatus in the form of a compressed and encoded content when it is instructed to reproduce the deleted content.

The information processing apparatus may further include a climax characteristic calculating unit that calculates a value of a climax characteristic representing a degree of climax of the details of the content as a deletion target in time series, and the recording and reproduction control unit may perform the compressing and encoding process on only a section in which the value of the climax characteristic calculated by the climax characteristic calculating unit is equal to or less than a predetermined threshold value in the content as a deletion target.

The information processing apparatus may further include a search unit that searches plural contents recorded in the different information processing apparatus for content identical or similar to the deleted content, the recording and reproduction control unit may record meta data allowing identification of details of the content as a deletion target on the predetermined recording medium, the search unit may search plural contents recorded in the different information processing apparatus for content identical or similar to the deleted content on the basis of the meta data recorded on the predetermined recording medium by the recording and reproduction control unit, and the recording and reproduction control unit may read and reproduce the content identical or similar to the deleted content and searched for by the search unit from the different information processing apparatus.

The meta data may be a feature quantity of each of plural scenes included in the content, and the search unit may search the scenes of the plural contents recorded in the different information processing apparatus for a scene having a feature quantity identical or similar to the feature quantity of each of the plural scenes of the deleted content.

The search unit may set a similar range of the feature quantity of each of the plural scenes of the deleted content on the basis of a predetermined allowable similarity.

The information processing apparatus may further include a display control unit that displays a warning for the scene searched for by the search unit after the allowable similarity is lowered by the search unit.

The recording and reproduction control unit may transmit meta data allowing identification of details of the content as a deletion target to the different information processing apparatus; may receive a detection result whether a different information processing apparatus having content identical or similar to the selected content is present from the different information processing apparatus; may record the meta data on the predetermined recording medium and delete the content as a deletion target when the detection result that a different information processing apparatus having content identical or similar to the selected content is present is received; may record the meta data on the predetermined recording medium, perform a compressing and encoding process on the content as a deletion target, transmit the resultant compressed and encoded data to the different information processing apparatus, and delete the content as a deletion target, when the detection result that a different information processing apparatus having content identical or similar to the selected content is not present is received; may transmit the meta data to the different information processing apparatus when it is instructed to reproduce the deleted content; may receive the compressed and encoded data when the compressed and encoded data is transmitted from the different information processing apparatus; and may receive the content when the content identical or similar to the deleted content is read and transmitted from the different information processing apparatus.

The meta data may be a feature quantity of the content as a deletion target.

The recording and reproduction control unit may select content satisfying a predetermined determination criterion as the content as a deletion target when the data capacity of new content which it is instructed to record on the predetermined recording medium is larger than a predetermined value based on free capacity of the predetermined recording medium.

The predetermined determination criterion may be set to a criterion that a user's access frequency is low.

The predetermined determination criterion may be set to a criterion that a user's operation details on an input unit are an instruction to delete predetermined content.

The embodiment of the present disclosure is also directed to an information processing method and a program corresponding to the above-mentioned information processing apparatus according to the embodiment of the present disclosure.

In the information processing apparatus and method and the program according to the embodiment of the present disclosure, content is recorded on a predetermined recording medium, content is read and reproduced from the predetermined recording medium, information necessary for reproducing deleted content is transmitted to and recorded on a different information processing apparatus when it is intended to delete the content as a deletion target recorded on the predetermined recording medium, and the deleted content is synthesized and reproduced on the basis of the information from the different information processing apparatus when it is instructed to reproduce the deleted content.

Another embodiment of the present disclosure is directed to an information processing apparatus including: a meta data managing unit that detects whether a second different information processing apparatus having content identical or similar to content as a deletion target is present on the basis of meta data allowing identification of details of the content as a deletion target received from a first different information processing apparatus when the first different information processing apparatus deletes the content as a deletion target, that records information of the second different information processing apparatus and the meta data of content identical or similar to the content as a deletion target and transmits a detection result that the second different information processing apparatus is present to the first different information processing apparatus when the second different information processing apparatus is present, and that transmits the detection result that the second different information processing apparatus is not present to the first different information processing apparatus, receives compressed and encoded data obtained by performing a compressing and encoding process on the content as a deletion target from the first different information processing apparatus, and records the received compressed and encoded data on a recording medium, when the second different information processing apparatus is not present; and a search unit that searches the recording medium for the compressed and encoded data on the basis of the meta data received again from the first different information processing apparatus when the first different information processing apparatus is instructed to reproduce the deleted content, that transmits the compressed and encoded data to the first different information processing apparatus when the compressed and encoded data is present, and that searches for the second different information processing apparatus having content identical or similar to the deleted content when the compressed and encoded data is not present.

The information processing apparatus may further include content managing unit that inquires the second different information processing apparatus whether to transmit content identical or similar to the deleted content to the first different information processing apparatus when the second different information processing apparatus having content identical or similar to the deleted content is searched for by the search unit, and that reads the content identical or similar to the deleted content from the second different information processing apparatus and transmits the read content to the first different information processing apparatus when the inquiry result of enabled transmission is received from the second different information processing apparatus.

The another embodiment of the present disclosure is also directed to a method and a program corresponding to the above-mentioned information processing apparatus according to the embodiment of the present disclosure.

In the information processing apparatus and method and the program according to the embodiment of the present disclosure, it is detected whether a second different information processing apparatus having content identical or similar to content as a deletion target is present on the basis of meta data allowing identification of details of the content as a deletion target received from a first different information processing apparatus when the first different information processing apparatus deletes the content as a deletion target, information of the second different information processing apparatus and the meta data of content identical or similar to the content as a deletion target are recorded, a detection result that the second different information processing apparatus is present is transmitted to the first different information processing apparatus when the second different information processing apparatus is present, the detection result that the second different information processing apparatus is not present is transmitted to the first different information processing apparatus, compressed and encoded data obtained by performing a compressing and encoding process on the content as a deletion target is received from the first different information processing apparatus, the received compressed and encoded data is recorded on a recording medium when the second different information processing apparatus is not present, the recording medium is searched for the compressed and encoded data on the basis of the meta data received again from the first different information processing apparatus when the first different information processing apparatus is instructed to reproduce the deleted content, the compressed and encoded data is transmitted to the first different information processing apparatus when the compressed and encoded data is present, and the second different information processing apparatus having content identical or similar to the deleted content is searched for when the compressed and encoded data is not present.

As described above, according to the embodiments of the present disclosure, it is possible to reproduce content identical or similar to deleted content.

### BRIEF DESCRIPTION OF THE DRAWINGS

FIG. 1 is a block diagram illustrating the configuration of content managing system according to a first embodiment of the present disclosure.

FIG. 2 is a diagram illustrating an archive process using a climax characteristic.

FIG. 3 is a block diagram illustrating the configuration of user recording and reproducing system.

FIG. 4 is a block diagram illustrating the configuration of a server.

FIG. 5 is a block diagram illustrating the functional configuration of a system controller.

FIG. 6 is a flowchart illustrating the flow of an archive process based on a climax characteristic.

FIG. 7 is a flowchart illustrating the flow of content reproducing procedure.

FIG. 8 is a block diagram illustrating the configuration of content managing system according to a second embodiment of the present disclosure.

FIG. 9 is a diagram illustrating reproduction of content.

FIG. 10 is a block diagram illustrating the functional configuration of a system controller.

FIG. 11 is a flowchart illustrating the flow of content deleting procedure.

FIG. 12 is a flowchart illustrating the flow of content reproducing procedure.

FIG. 13 is a block diagram illustrating the configuration of content managing system according to a third embodiment of the present disclosure.

FIG. 14 is a diagram illustrating reproduction of content.

FIG. 15 is a block diagram illustrating the functional configuration of a management unit.

FIG. 16 is a flowchart illustrating the flow of content deleting procedure.

FIG. 17 is a flowchart illustrating the flow of content managing procedure for deletion.

FIG. 18 is a flowchart illustrating the flow of content reproducing procedure.

FIG. 19 is a flowchart illustrating the flow of content managing procedure for reproduction.

### DETAILED DESCRIPTION

Three embodiments (hereinafter, referred to as a first embodiment to a third embodiment) will be described in the following order as a preferred embodiment of the present disclosure.

1. First Embodiment (Example where Archive Process is Performed on Content)

2. Second Embodiment (Example where only Meta Data is recorded and Content Data is deleted)

3. Third Embodiment (Example where Similar Content is Searched for from Contents Recorded in Other User Recording and Reproducing System)

Here, content means a movie, a music, a drama, a literature, a photograph, a cartoon, an animation, a computer game, a character, a figure, a color, an audio, an action, or a video, or combinations thereof, or a program (which means a combination of commands to a computer for obtaining a single result) providing information associated therewith via a computer. In these embodiments, it is assumed that a video (moving image) is employed as content. In these embodiments, since content is recorded on a recording medium, the content has the form of data which can be recorded on the recording medium.

Hereinafter, embodiments of the present disclosure will be described with reference to the accompanying drawings.

### 1. First Embodiment

### [Configuration of Content Managing System]

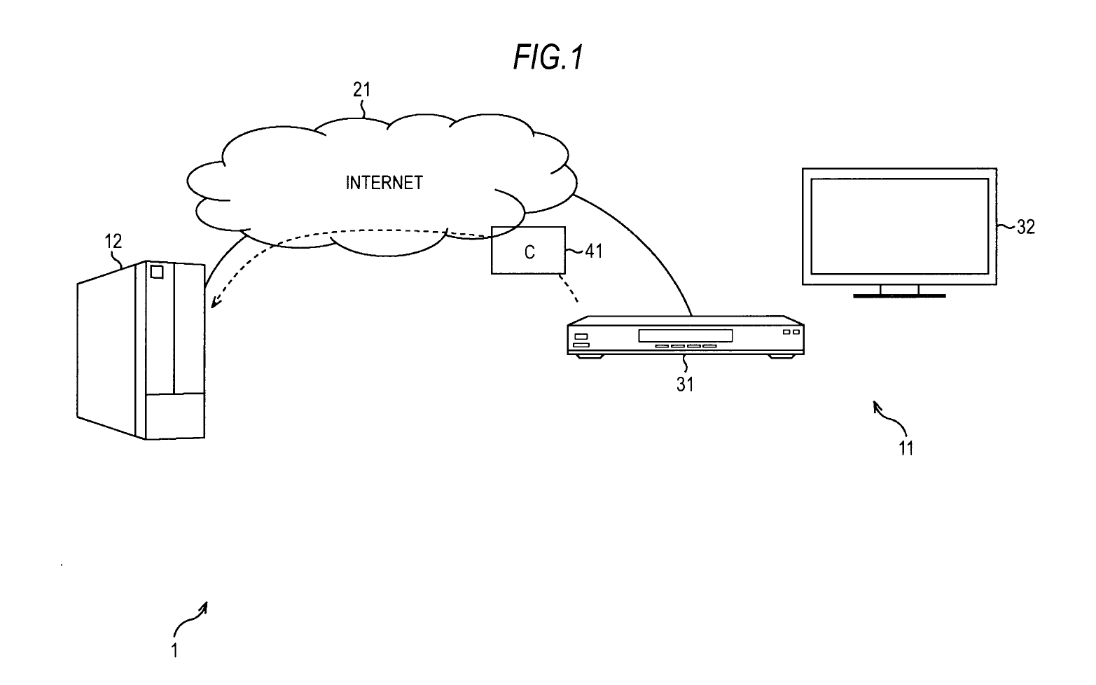

FIG. 1 is a block diagram illustrating the configuration of content managing system according to a first embodiment of the present disclosure.

The content managing system 1 shown in FIG. 1 has a configuration in which a user recording and reproducing system 11 and a server 12 are connected to each other via the Internet 21. The user recording and reproducing system 11 includes a recording and reproducing apparatus 31 and a display 32.

The recording and reproducing apparatus 31 can record content on a recording medium and can read and reproduce the content from the recording medium. Here, since the recording capacity of the recording medium is finite, the recording and reproducing apparatus 31 determines whether the free capacity of the recording medium is sufficient for the data capacity of new content before recording the new content on the recording medium.

The recording and reproducing apparatus 31 performs an archive process when determining that the free capacity of the recording medium is not sufficient for recording the new content. That is, the recording and reproducing apparatus 31 performs the archive process when the data capacity of the new content instructed to record on the recording medium is larger than a predetermined value on the basis of the free capacity of the recording medium.

The archive process means a series of processes described below. That is, the apparatus (the recording and reproducing apparatus 31 in this embodiment) selects content satisfying a predetermined determination criterion as content to be archived out of one or more contents (hereinafter, referred to as recorded contents) recorded on a predetermined recording medium (a recording medium of the recording and reproducing apparatus 31 in this embodiment). The apparatus performs a predetermined compressing and encoding process on the content to be archived. Hereafter, the content having been subjected to the compressing and encoding process is referred to as a compressed and encoded content. The apparatus records the compressed and encoded content on a recording medium (a recording medium of the server 12 in this embodiment) other than the predetermined recording medium. This series of processes is an archive process and the content having been subjected to the archive process is deleted from the predetermined recording medium.

Here, the predetermined determination criterion used to select an archive target is not particularly limited but may be a criterion that the elapsed time after content is recorded on a predetermined recording medium is the longest. In this embodiment, a criterion that a user's access frequency is low is employed. That is, in this embodiment, the recording and reproducing apparatus 31 selects content with a low access frequency by a user (which is, for example, the lowest or lower than a predetermined reference value), for example, the content 41, as the content to be archived out of one or more recorded contents. The recording and reproducing apparatus 31 performs a predetermined compressing and encoding process on the content 41 to be archived and records the resultant compressed and encoded content 41 on a recording medium of the server 12 other than the predetermined recording medium.

The number of predetermined determination criteria for selecting an archive target is not particularly limited, but is two in this embodiment. That is, in this embodiment, a determination criterion that operation details on an input unit (that is, a remote controller or the like) by a user are an instruction to delete predetermined content is employed in addition to the determination criterion of the low access frequency described above.

For example, it is assumed that a user instructs to delete the content 41 by operating the input unit in a state where the content 41 does not satisfy the determination reference that the access frequency is low. In this case, the recording and reproducing apparatus 31 performs the archive process on the content 41 and records the resultant content on the recording medium of the server 12, which is another recording medium, in the form of compressed and encoded data. Accordingly, even when a user erroneously deletes the content 41, the content 41 is subjected to the archive process and is recorded on the recording medium of the server 12.

The server 12 receives and records the compressed and encoded content 41 from the recording and reproducing apparatus 31. Accordingly, the content 41 is in a state where the archive process is performed thereon (hereinafter, referred to as an archived state).

When reproducing the content 41 in the archived state, the recording and reproducing apparatus 31 receives the compressed and encoded content 41 from the server 12, and decompresses, decodes, reproduces, and displays the received content on the display 32.

When performing the archive process on the content 41, the recording and reproducing apparatus 31 may set all sections of the content 41 as a target or may set some sections as a target. When performing the archive process on some sections of the content 41, the recording and reproducing apparatus 31 performs the archive process, for example, depending on a degree of climax of the details of the content 41. That is, the recording and reproducing apparatus 31 performs the archive process on only the section in which the details of the content 41 are not in a climax and the recording and reproducing apparatus 31 records the section in which the details are in a climax.

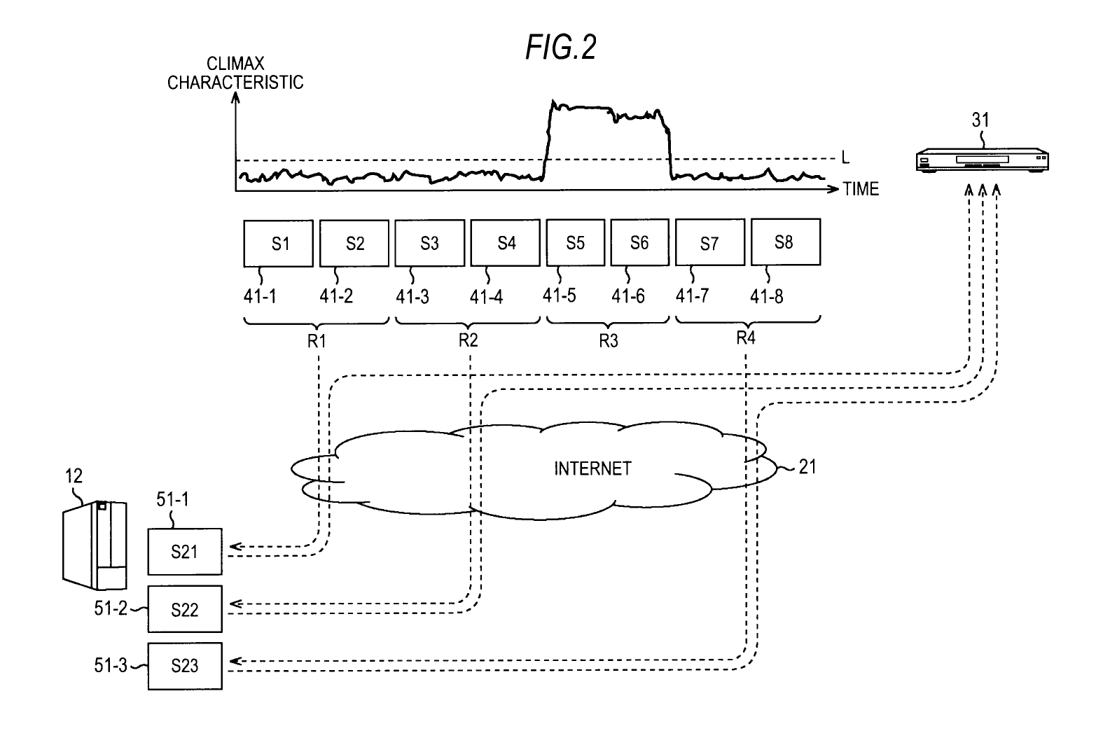

An example where the archive process is performed depending on the degree of climax of the details of the content 41 will be described with reference to FIG. 2.

### [Archive Process Using Climax Characteristic]

FIG. 2 is a diagram illustrating the archive process using a climax characteristic.

The climax characteristic is a temporal change of a value representing the degree of climax of the details of the content and means that as the value is higher, the details climax more. The degree of climax is an estimated value of a climax felt by plural viewers. The climax characteristic is a value calculated on the basis of a variation in video feature quantity and a variation in audio feature quantity of the content.

The uppermost graph in FIG. 2 is a graph illustrating the climax characteristic of the content 41 as an archive target. In the graph, the vertical axis represents the instantaneous value of the climax characteristic and the horizontal axis represents the time. In the climax characteristic, a predetermined threshold value L is set in advance.

The second uppermost diagram in FIG. 2 shows the content 41 as an archive target. The content 41 includes scenes 41-1 to 41-M (where M is an integer equal to or greater than 2). A scene is a video of a predetermined section partitioned in the content and content is a set of plural scenes. The scenes 41-1 to 41-M are continuously reproduced in this order. In FIG. 2, it is assumed that M is equal to or greater than 8 and only the scenes 41-1 to 41-8 out of the scenes 41-1 to 41-M are shown.

As shown in the second uppermost diagram, since the value of the climax characteristic in a section R1 of the content 41 including the scenes 41-1 and 41-2 is equal to or less than the threshold value L, the section R1 is a target of an archive process. Specifically, the section R1 of the content 41 including the scenes 41-1 and 41-2 is subjected to a predetermined compressing and encoding process and becomes compressed and encoded data 51-1. The compressed and encoded data 51-1 is transmitted to the server 12 via the Internet 21, is recorded on the recording medium of the server 12, is in an archived state. As a result, the scenes 41-1 and 41-2 are deleted from the recording medium of the recording and reproducing apparatus 31.

Similarly, since the value of the climax characteristic in a section R2 of the content 41 including the scenes 41-3 and 41-4 is equal to or less than the threshold value L, the section R2 is a target of the archive process. Specifically, the section R2 of the content 41 including the scenes 41-3 and 41-4 is subjected to a predetermined compressing and encoding process and becomes compressed and encoded data 51-2. The compressed and encoded data 51-2 is transmitted to the server 12 via the Internet 21, is recorded on the recording medium of the server 12, and is in an archived state. As a result, the scenes 41-3 and 41-4 are deleted from the recording medium of the recording and reproducing apparatus 31.

On the other hand, since the value of the climax characteristic in a section R3 of the content 41 including the scenes 41-5 and 41-6 is larger than the threshold value, the section R3 is not a target of the archive process. Accordingly, the section R3 of the content 41 including the scenes 41-5 and 41-6 remains to be recorded on the recording medium of the recording and reproducing apparatus 31.

Since the value of the climax characteristic in a section R4 of the content 41 including the scenes 41-7 and 41-8 is equal to or less than the threshold value L, the section R4 is a target of the archive process. Specifically, the section R4 of the content 41 including the scenes 41-7 and 41-8 is subjected to a predetermined compressing and encoding process and becomes compressed and encoded data 51-3. The compressed and encoded data 51-3 is transmitted to the server 12 via the Internet, is recorded on the recording medium of the server 12, and is in an archived state. As a result, the scenes 41-7 and 41-8 are deleted from the recording medium of the recording and reproducing apparatus 31.

In this way, when the recording and reproducing apparatus 31 determines that the free capacity of a recording medium is not sufficient for the data capacity of new content before recording the new content on the recording medium, it performs the archive process on some sections R1, R2, and R4 of the content 41 as an archive target and deletes the sections from the recording medium. Therefore, the free capacity corresponding to the data of the sections R1, R2, and R4 of the content 41 as an archive target is guaranteed in the recording medium of the recording and reproducing apparatus 31.

Without a user's clear operation, the recording and reproducing apparatus 31 autonomously performs the archive process to guarantee the free capacity before the free capacity disappears. Accordingly, since the free capacity necessary for recording new content is guaranteed in the recording medium, a user can instruct to record a desired content on the recording medium without determining whether the free capacity is present.

The recording and reproducing apparatus 31 receives the compressed and encoded data 51-1 to 51-3 from the server 12 and records the compressed and encoded data on the recording medium, when it is instructed to reproduce the content 41 in the archived state. The recording and reproducing apparatus 31 decompresses and decodes the compressed and encoded data 51-1 to 51-3 to acquire the scenes 41-1 to 41-4, 41-7, and 41-8, synthesizes and reproduces the content including the scenes 41-5 and 41-6 recorded in the recording and reproducing apparatus 31, and displays the content on the display 32.

Since the archive process is performed on the content 41 in this way, the user can view the content 41 actually deleted from the recording and reproducing apparatus 31. That is, the user can view the content 41 even when the content 41 is erroneously deleted.

When it is instructed to reproduce the content 41 having been subjected to the archive process, the recording and reproducing apparatus 31 displays a message indicating that the content 41 is in the archived state. The recording and reproducing apparatus 31 performs a display so that it is possible to select instructions of reproduction of all the sections of the content 41 and reproduction of only a climax section.

When it is instructed to reproduce all the sections of the content 41, the recording and reproducing apparatus 31 receives, decompresses, and decodes the compressed and encoded data 51-1 to 51-3 from the server 12 as described above and synthesizes and reproduces the content including the scenes 41-5 and 41-6 recorded on the recording and reproducing apparatus 31.

On the other hand, when it is instructed to reproduce only the climax section of the content 41, the recording and reproducing apparatus 31 reads and reproduces the scenes 41-5 and 41-6 recorded on the recording medium. Accordingly, when it is instructed to reproduce only the climax section of the content 41, the time until performing the reproduction is shortened, compared with the case where it is instructed to reproduce all the sections of the content 41.

### [Configuration of User Recording and Reproducing System]

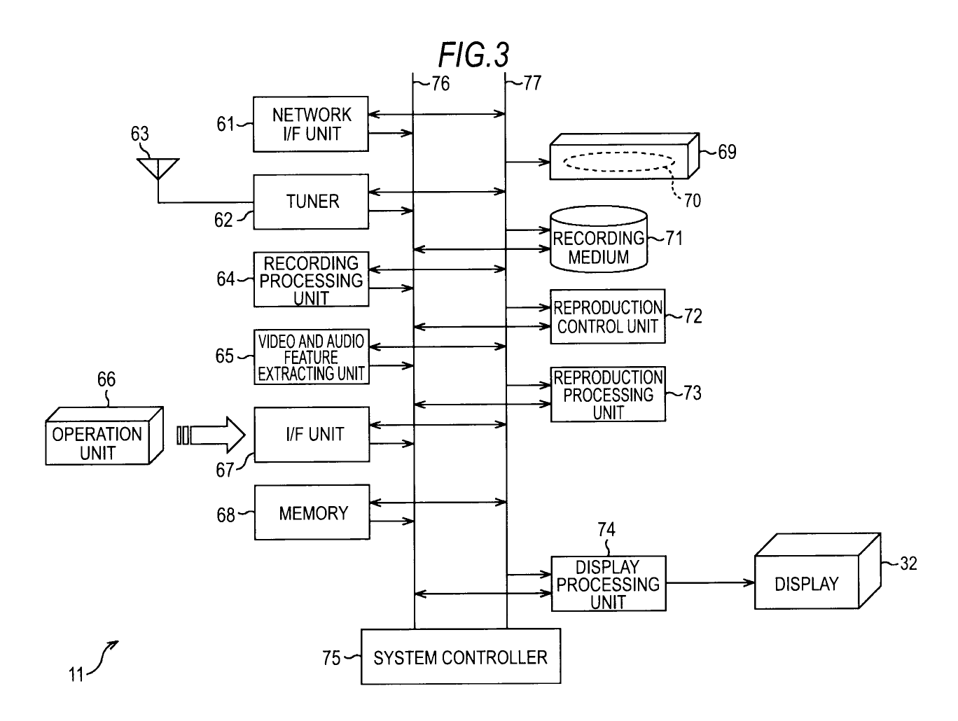

FIG. 3 is a block diagram illustrating the configuration of the user recording and reproducing system 11 of the content managing system 1 shown in FIG. 1.

The user recording and reproducing system 11 has a configuration in which a network I/F unit 61, a tuner 62, a recording processing unit 64, a video and audio feature extracting unit 65, an operation unit 66, an I/F unit 67, a memory 68, and a disk drive 69 are connected to each other via a control bus 77. The user recording and reproducing system 11 also has a configuration in which a recording medium 71, a reproduction control unit 72, a reproduction processing unit 73, a display processing unit 74, and a system controller 75 are connected to each other via the control bus 77. The display 32 is connected to the display processing unit 74. Elements of the user recording and reproducing system 11 transmit and receive data to and from each other via a data bus 76.

The user recording and reproducing system 11 is connected to the Internet 21 via the network I/F unit 61. That is, Content transmitted from the server 12 is received by the network I/F unit 61 from the Internet 21 and is supplied to the recording processing unit 64.

The tuner 62 receives electric waves of a compressed and encoded content transmitted from the server 12 via the antenna 63. The tuner 62 demodulates the received electric waves, performs various processes on the resultant video signal and the resultant content, and supplies the processed video signal and content to the recording processing unit 64.

The tuner 62 receives a broadcast signal corresponding to a broadcast wave of a selected broadcast station of plural broadcast stations through the use of the antenna 63, performs various processes on the broadcast signal, and supplies the processed broadcast signal to the recording processing unit 64. The broadcast signal may also include EPG (Electronic Program Guide) information of a television broadcast program scheduled to be broadcast or currently being broadcast.

The recording processing unit 64 converts the video signal of the content received by the tuner 62 and the like into a format suitable for recording the video signal on the recording medium 71, for example, the format of compressed and encoded data based on a predetermined compression and encoding system and records the compressed and encoded data on the recording medium 71.

The video and audio feature extracting unit 65 extracts a video feature quantity and an audio feature quantity (hereinafter, referred to as feature quantity) for content or for each scene included in each content and supplies the extracted feature quantities to the system controller 75. The feature quantities are used to calculate the climax characteristics representing the degree of climax of the details of the content.

The operation unit 66 is constructed by a remote controller having buttons or a dial and the like and receives a predetermined operation of a user. The user can instruct to reproduce, record, and the like the content by operating the operation unit 66.

The I/F unit 67 supplies an operation signal based on the predetermined operation received through the use of the operation unit 66 to the system controller 75.

The memory 68 is constructed by a ROM (Read Only Memory), a RAM (Random Access Memory), and the like and appropriately stores data necessary for the system controller 75 performing various processes and the like.

The disk driver 69 is appropriately mounted with a removable medium 70 such as a magnetic disk, an optical disc, an optic-magnetic disk, or a semiconductor memory.

The recording medium 71 is constructed by a hard disk, a flash memory, or the like, and records the compressed and encoded content supplied from the recording processing unit 64.

The reproduction control unit 72 controls the processes of the reproduction processing unit 73 in response to an instruction from the system controller 75.

The reproduction processing unit 73 reproduces the compressed and encoded content recorded on the recording medium 71 under the control of the reproduction control unit 72.

The display processing unit 74 converts the content to be reproduced by the reproduction processing unit 73 into a format suitable for displaying the content on the display 32 and supplies the resultant content to the display 32.

The display 32 displays the content supplied from the display processing unit 74.

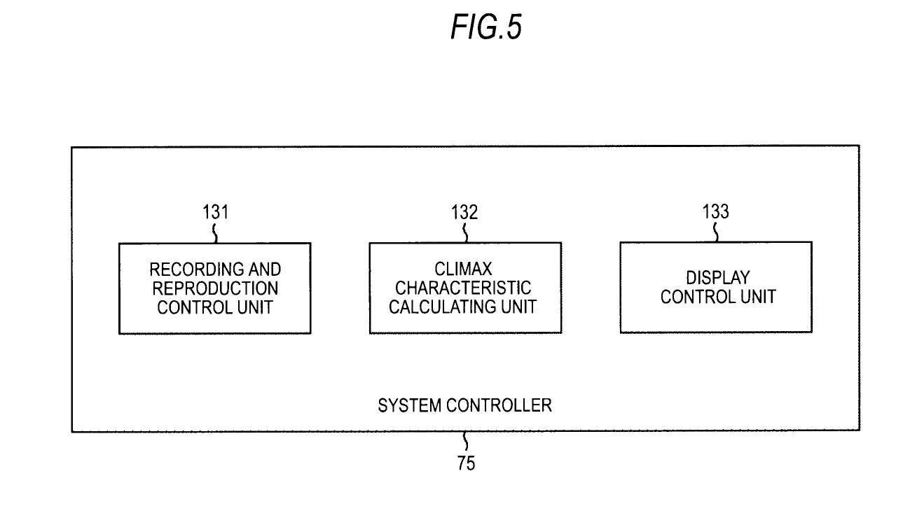

The system controller 75 controls the overall processes of the user recording and reproducing system 11. The detailed functions of the system controller 75 will be described later with reference to FIG. 5.

### [Configuration of Server]

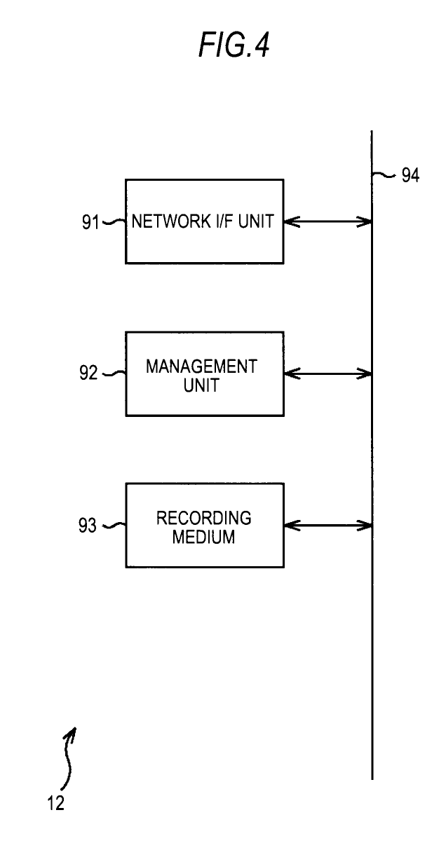

FIG. 4 is a block diagram illustrating the configuration of the server 12 in the content managing system 1 shown in FIG. 1.

The server 12 has a configuration in which a network I/F unit 91, a management unit 92, and a recording medium 93 are connected to each other via an inter/intra network 94.

The server 12 is connected to the Internet 21 via the network I/F unit 91.

The management unit 92 manages the content transmitted from the user recording and reproducing system 11 and the like.

The recording medium 93 is constructed by a hard disk, a flash memory, or the like and records the content transmitted from the user recording and reproducing system 11 and the like.

### [Functional Configuration of System Controller]

FIG. 5 is a block diagram illustrating the functional configuration of the system controller 75 in the user recording and reproducing system 11.

The system controller 75 includes a recording and reproduction control unit 131, a climax characteristic calculating unit 132, and a display control unit 133.

The recording and reproduction control unit 131 records content on the recording medium 71 and reads and reproduces content from the recording medium 71. The recording and reproduction control unit 131 performs processes of monitoring the free capacity of the recording medium 71, recording and reproducing content, and archiving the content.

The climax characteristic calculating unit 132 calculates the climax characteristic from the feature quantities for each scene included in the content and supplied from the video and audio feature extracting unit 65. That is, the climax characteristic calculating unit 132 calculates the values of the climax characteristics on the basis of the variation in video feature quantity of the content 41 (that is, in which the video feature quantity can be determined to actively rise) and the variation in audio feature quantity (that is, in which the audio level can be determined to actively rise).

The display control unit 133 performs a control of displaying an inquiry to a user or the like on the display 32.

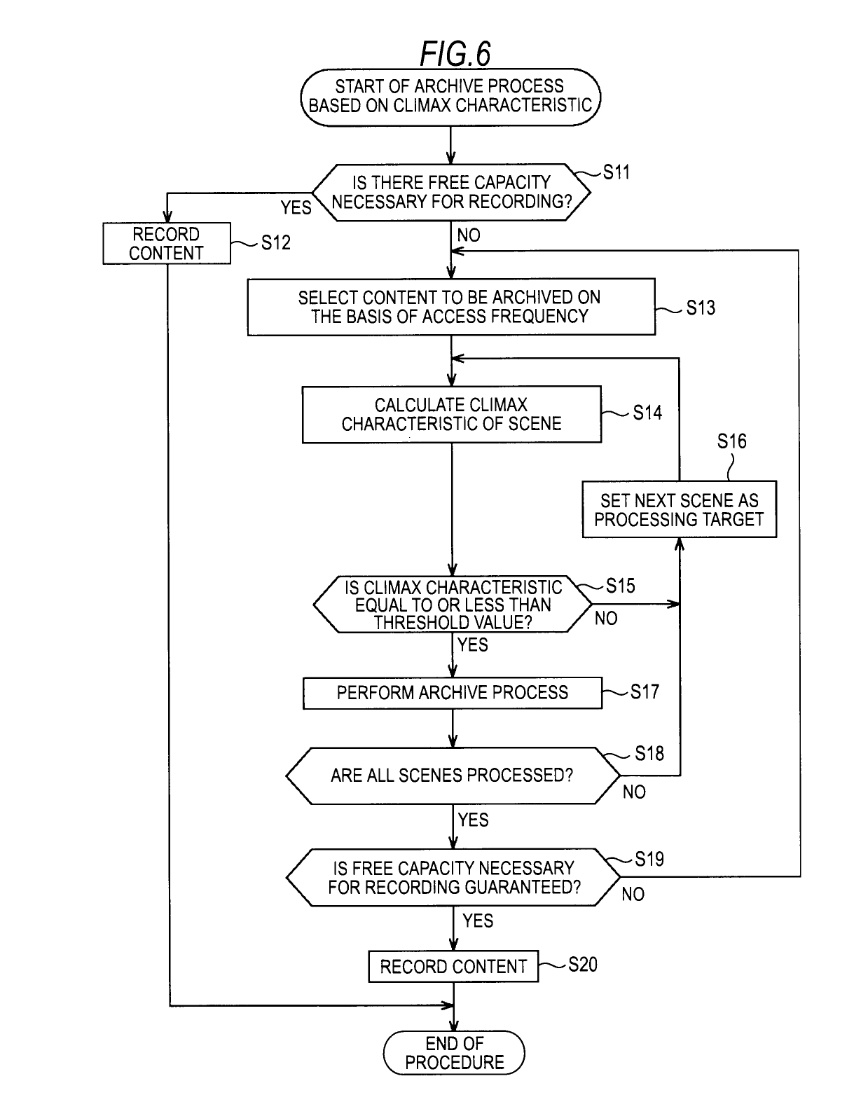

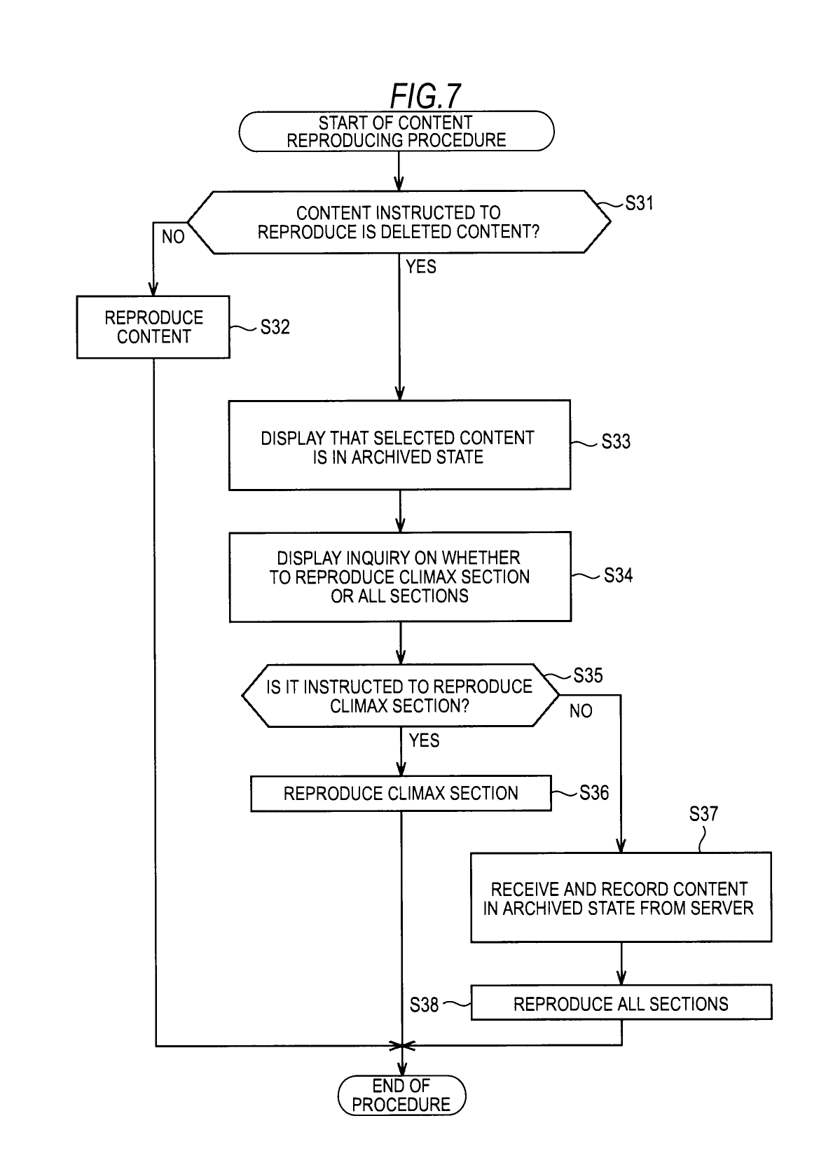

The archive process based on the climax characteristic described with reference to FIG. 2 and a procedure (hereinafter, referred to as content reproducing process) of reproducing the content subjected to the archive process will be described below with reference to FIGS. 6 and 7.

### [Archive Process Based on Climax Characteristic]

FIG. 6 is a flowchart illustrating the flow of the archive process based on the climax characteristic.

The archive process based on the climax characteristic is started when it is instructed to record new content in response to an operation signal from the operation unit 66 having received the user's predetermined operation.

In step S11, the recording and reproduction control unit 131 determines whether free capacity necessary for recording the new content is present in the recording medium 71.

When a broadcast program is employed as the content, for example, the free capacity of the recording medium 71 necessary for recording the content is calculated as follows. As described above, in this embodiment, the EPG information included in the broadcast signal is appropriately received by the tuner 62 and is recorded on the recording medium 71 in advance. Therefore, the recording and reproduction control unit 131, for example, reads the EPG information including the program from the recording medium 71, acquires a broadcast start time and a broadcast end time of the program from the EPG information, and calculates the broadcast time of the program from the acquired times. The recording and reproduction control unit 131 calculates the capacity necessary for recording the program on the basis of the broadcast time and determines whether the free capacity necessary for recording is present by comparing the calculated capacity with the free capacity of the recording medium 71.

When the free capacity necessary for recording is present, the determination result of step Sll is YES and the flow of processes goes to step S12.

In step S12, the recording and reproduction control unit 131 records the new content on the recording medium 71. That is, in this case, the new content is recorded on the recording medium 71 without any change.

Accordingly, the archive process based on the climax characteristic is ended.

On the contrary, when the free capacity necessary for recording is not present, the determination result of step S11 is NO and the flow of processes goes to step S13.

In step S13, the recording and reproduction control unit 131 selects content as an archive target on the basis of its access frequency. That is, the recording and reproduction control unit 131 selects content having a low access frequency by a user as the content as an archive process out of the recorded contents. Hereinafter, it is assumed that the content 41 shown in FIG. 2 is selected as the content as an archive target.

In step S14, the climax characteristic calculating unit 132 calculates the climax characteristics of the scenes included in the content 41. That is, the climax characteristic calculating unit 132 calculates the climax characteristics of the scenes included in the content 41 from the feature quantities for each scene included in the content 41 and extracted by the video and audio feature extracting unit 65. Specifically, for example, the climax characteristic calculating unit 132 calculates the climax characteristic of the scene 41-1 shown in FIG. 2.

In step S15, the climax characteristic calculating unit 132 determines whether the value of the climax characteristic of the scene 41-1 is equal to or less than the threshold value L.

When the value of the climax characteristic is equal to or less than the threshold value L, the determination result of step S15 is YES and the flow of processes goes to step S17. For example, as shown in FIG. 2, since the value of the climax characteristic of the scene 41-1 is equal to or less than the threshold value L, the determination result of step S15 is YES. The process of step S17 and processes of the subsequent steps will be described later.

On the contrary, when the value of the climax characteristic is larger than the threshold value L, the determination result of step S15 is NO and the flow of processes goes to step S16. For example, as in the scene 41-5 of FIG. 2, when the value of the climax characteristic is larger than the threshold value L, the determination result of step S15 is NO.

In step S16, when the climax characteristic calculating unit 132 sets a next scene as a processing target, the flow of processes is returned to step S14 and the subsequent processes are repeated. That is, until the value of the climax characteristic of the scene is equal to or less than the threshold value L, the loop processes of steps S14 to S16 are repeated. While the loop processes of steps S14 to S16 are repeated, a scene of which the value of the climax characteristic is larger than the threshold value L is not subjected to the archive process but is recorded on the recording medium 71.

Thereafter, when the value of the climax characteristic of the scene is equal to or less than the threshold value L, the determination result of step S15 is YES and the flow of processes goes to step S17.

In step S17, the recording and reproduction control unit 131 performs the archive process. That is, the recording and reproduction control unit 131 performs a predetermined compressing and encoding process on the scene of which the value of the climax characteristic is equal to or less than the threshold value L and transmits the results to the server 12. Accordingly, the corresponding scene is deleted from the recording medium 71. For example, as shown in FIG. 2, the scenes 41-1 and 41-2 are subjected to the predetermined compressing and encoding process and become the compressed and encoded data 51-1 and the compressed and encoded data is transmitted to the server 12 via the Internet 21. The compressed and encoded data 51-1 is recorded on the recording medium 93 of the server 12 and is in the archived state. As a result, the scenes 41-1 and 41-2 are deleted from the recording medium 71.

In step S18, the recording and reproduction control unit 131 determines whether all the scenes included in the content 41 are processed. That is, the recording and reproduction control unit 131 determines whether all the scenes 41-1 to 41-M included in the content 41 are processed, as shown in FIG. 2.

When all the scenes are not processed yet, the determination result of step S18 is NO, the flow of processes is returned to step S16, and the subsequent processes thereof are repeated. That is, the loop processes of steps S14 to S18 are repeated until all the scenes are processed.

Thereafter, when all the scenes are processed, the determination result of step S18 is YES and the flow of processes goes to step S19.

In step S19, the recording and reproduction control unit 131 determines whether the free capacity necessary for recording is guaranteed in the recording medium 71. That is, the recording and reproduction control unit 131 determines whether the free capacity necessary for recording the new content is guaranteed in the recording medium 71 by deleting some sections (that is, sections not being in a climax) of the content 41 as an archive target from the recording medium 71.

When the free capacity necessary for recording is not guaranteed in the recording medium 71 yet, the determination result of step S19 is NO, the flow of processes is returned to step S13, and the subsequent processes thereof are repeated. That is, the loop processes of steps S13 to S19 are repeated until the free capacity necessary for recording the new content is guaranteed in the recording medium 71.

Thereafter, when the free capacity necessary for recording the new content is guaranteed in the recording medium 71, the determination result of step S19 is YES and the flow of processes goes to step S20.

In step S20, the recording and reproduction control unit 131 records the new content on the recording medium 71.

Accordingly, the archive process based on the climax characteristic is ended.

In the example shown in FIG. 6, the criterion that the user's access frequency is low is employed as a predetermined determination criterion for selecting an archive target. However, as described above, the determination criterion that the user's operation details on the input unit are an instruction to delete predetermined content may be employed. That is, even when the content 41 is deleted in response to the operation signal from the operation unit 66 having received the user's predetermined operation, the archive process is performed on the content 41.

In this case, the flow of processes shown in FIG. 6 is started from step S13 and the content instructed to delete in response to the operation signal from the operation unit 66 having received the user's predetermined operation in step S13 is the content as an archive target. The subsequent processes thereof are the same as the processes of steps S14 to S18 in FIG. 6. When the determination result of step S18 is YES, the flow of processes is ended.

As a result of the archive process based on the climax characteristic, the content as an archive target is recorded on the recording medium 93 of the server 12, is in the archived state, and is deleted from the recording medium 71. Accordingly, the free capacity necessary for recording the new content is guaranteed in the recording medium 71.

Even content deleted from the recording medium 71 as a result of the archive process is recorded in the server 12. Accordingly, the user can reproduce the content deleted from the recording medium 71.

### [Content Reproducing Procedure]

FIG. 7 is a flowchart illustrating the flow of the content reproducing procedure.

The content reproducing procedure is started when it is instructed to reproduce content in response to an operation signal from the operation unit 66 having received a user's predetermined operation.

In step S31, the recording and reproduction control unit 131 determines whether the content instructed to reproduce is deleted content. That is, the recording and reproduction control unit 131 determines whether the content instructed to reproduce is content deleted from the recording medium 71 as the result of the archive process.

When the content instructed to reproduce is not deleted content, the determination result of step S31 is No and the flow of processes goes to step S32.

In step S32, the recording and reproduction control unit 131 reproduces the content instructed to reproduce. When the content instructed to reproduce is not deleted content, the content is recorded on the recording medium 71. Accordingly, the recording and reproduction control unit 131 reads and reproduces the content recorded on the recording medium 71.

Accordingly, the content reproducing procedure is ended.

On the contrary, when the content instructed to reproduce is deleted content, the determination result of step S31 is YES and the flow of processes goes to step S33. Hereinafter, it is assumed that the deleted content is the content 41 deleted through the procedure shown in FIG. 6.

In step S33, the display control unit 133 displays that selected content 41 is in the archived state.

In step S34, the display control unit 133 displays an inquiry on whether to reproduce the climax section of the selected content 41 or all the sections. By operating the operation unit 66 for the displayed inquiry, the user can select whether to reproduce the climax section of the selected content or all the sections.

In step S35, the recording and reproduction control unit 131 determines whether it is instructed to reproduce the climax section of the content 41.

When it is instructed to reproduce the climax section of the content 41, the determination result of step S35 is YES and the flow of processes goes to step S36.

In step S36, the recording and reproduction control unit 131 reproduces the climax section of the content 41. That is, the recording and reproduction control unit 131 reads and reproduces the scenes 41-5 and 41-6 not deleted but recorded on the recording medium 71. As a result, the content reproducing procedure is ended.

On the contrary, when it is not instructed to reproduce the climax section of the content 41 in step S35, that is, when it is instructed to reproduce all the sections of the content 41, the determination result of step S35 is NO and the flow of processes goes to step S37.

In step S37, the recording and reproduction control unit 131 receives the compressed and encoded content 41 from the server 12 and records the compressed and encoded content 41 on the recording medium 71. That is, the recording and reproduction control unit 131 receives the compressed and encoded data 51-1 to 51-3 from the server 12 and records the received compressed and encoded data on the recording medium 71.

In step S38, the recording and reproduction control unit 131 reproduces all the sections of the content 41. That is, the recording and reproduction control unit 131 decompresses and decodes the compressed and encoded data 51-1 to 51-3. Then, the recording and reproducing apparatus 31 synthesizes and reproduces the content including the decompressed and decoded scenes 41-1 to 41-4, 41-7, and 41-8 and the scenes 41-5 and 41-6 recorded on the recording and reproducing apparatus 31.

As a result, the content reproducing procedure is ended.

Through the content reproducing procedure, the user can view the content having been subjected to the archive process to guarantee the recording capacity and deleted from the recording medium 71. In addition, even when the user deletes content by oneself, the user can view the deleted content. The user can rapidly see the gist of the content by instructing to reproduce the climax section.

In the above-mentioned example, when the archive process is performed on some sections of the content 41, the sections to be subjected to the archive process is determined on the basis of the climax characteristic of the content 41. However, the determination of the sections of the content 41 to be subjected to the archive process is not limited to the climax characteristic. For example, the archive process may be performed on the sections other than the section favorably designated by the user in the content 41. That is, a favorably-designated section of the content 41 may be inhibited from being subjected to the archive process.

### 2. Second Embodiment

In the first embodiment, the recording and reproducing apparatus guarantees the free capacity necessary for recording new content by performing the archive process on content and deleting the content from the recording medium as a result. However, the method of guaranteeing the free capacity necessary for recording new content is not limited to this configuration. For example, the recording and reproducing apparatus may guarantee the free capacity for recording by leaving only meta data capable of identifying the details of content on the recording medium and deleting the content itself.

### [Configuration of Content Managing System]

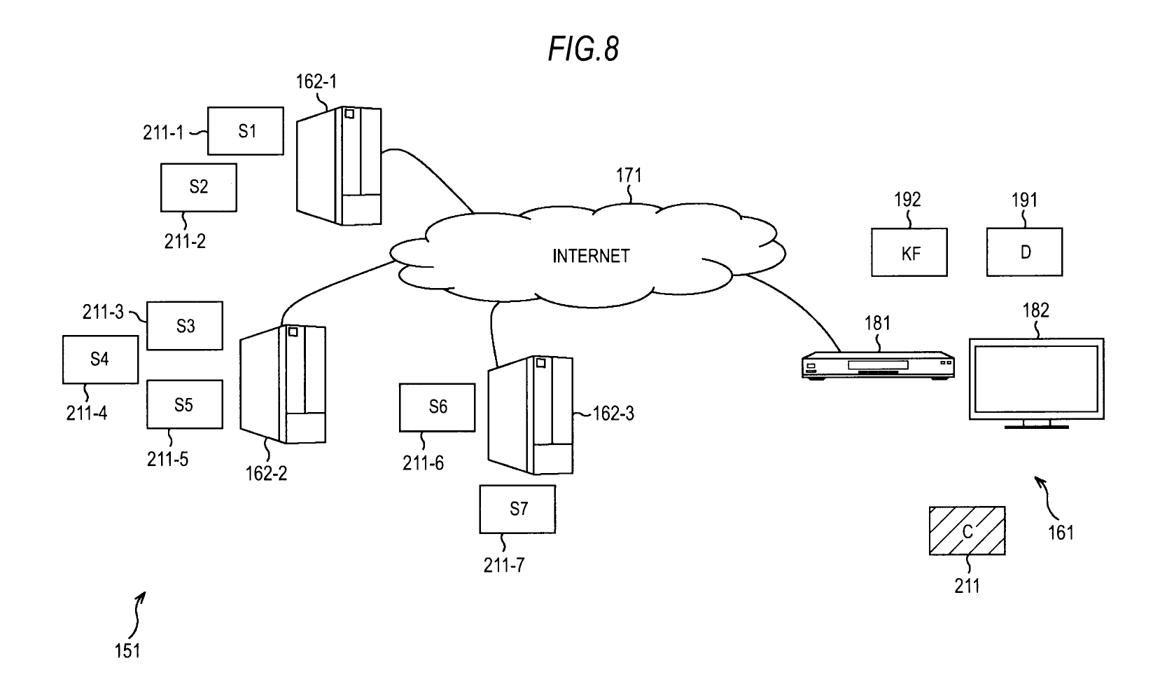

FIG. 8 is a block diagram illustrating the configuration of content managing system according to the second embodiment of the present disclosure.

The content managing system 151 shown in FIG. 8 has a configuration in which a user recording and reproducing system 161 and servers 162-1 to 162-N (where N is an integer equal to or greater than 2 and is 3 in the example shown in FIG. 8) are connected to each other via the Internet 171. The user recording and reproducing system 161 includes a recording and reproducing apparatus 181 and a display 182. Hereinafter, when the servers 162-1 to 162-3 do not have to be distinguished individually, these are referred to as the servers 162. It is assumed that the server 162 is a commercially-available server and records a large number of contents therein.

The basic configurations of the user recording and reproducing system 161 and the servers 162 are the same as the configurations of the user recording and reproducing system shown in FIG. 3 and the server 12 shown in FIG. 4. Accordingly, the configurations of the user recording and reproducing system 11 shown in FIG. 3 and the server 12 shown in FIG. 4 are incorporated therein by reference as the configurations of the user recording and reproducing system 161 and the servers 162 shown in FIG. 8.

The recording and reproducing apparatus 181 determines whether the free capacity of the recording medium 71 is sufficient for the data capacity of new content before recording the new content on the recording medium. When determining that the free capacity necessary for recording the new content is not present on the recording medium 71, the recording and reproducing apparatus 181 selects content having a low access frequency by the user out of the recorded contents as content to be deleted. In FIG. 8, it is assumed that the content 211 is selected as content to be deleted.

The recording and reproducing apparatus 181 records only meta data 191 capable of identifying the details of the selected content 211 to be deleted on the recording medium 71 and deletes the content 211 itself. In this embodiment, the feature quantities of each scene of the content 211 extracted by the video and audio feature extracting unit 65 are employed as the meta data 191.

As described later, the recording and reproducing apparatus 181 can reproduce content (hereinafter, referred to as similar content) having a feature quantity identical or similar to the content 211 by using the feature quantities for each scene of the content 211 recorded on the recording medium 71. That is, when the feature quantities for each scene of the content 211 are recorded on the recording medium 71, the recording and reproducing apparatus 181 can delete the content 211 having a large amount of data itself. Accordingly, the free capacity necessary for recording the new content is guaranteed in the recording medium 71.

The recording and reproducing apparatus 181 records a key frame 192 of the content 211 on the recording medium 71 along with the feature quantities for each scene of the content 211. A key frame means, for example, a frame included in a scene having the highest value of the climax characteristic out of the scenes included in the content 211. The key frame 192 can be used as a thumbnail image of the deleted content 211. For example, the recording and reproducing apparatus 181 can use the key frame 192, when the thumbnail image of the content 211 actually deleted from the recording medium 71 is used to display the thumbnail images of plural contents recorded on the recording medium 71.

When it is instructed to reproduce the deleted content 211, the recording and reproducing apparatus 181 extracts the feature quantities for each scene of the content 211 recorded on the recording medium 71. The recording and reproducing apparatus 181 searches scenes included in plural contents recorded in the server 162 for a scene (hereinafter, referred to as a similar scene) having a feature quantity identical or similar to the feature quantity of each scene of the content 211 for each scene of the content 211.

The recording and reproducing apparatus 181 searches the scenes included in plural contents recorded in the server 162 for a similar scene on the basis of a predetermined allowable similarity. An allowable similarity means a similarity by which a scene can be allowed as a similar scene of a predetermined scene. That is, a scene of which the similarity to a predetermined scene is equal to or more than the allowable similarity is searched for as a similar scene and a scene of which the similarity to a predetermined scene is less than the allowable similarity is not searched for as a similar scene. Accordingly, by setting the allowable similarity to a predetermined value, a range of scenes which can be searched for as a scene similar to a predetermined scene can be freely changed. Therefore, when it is intended to increase the number of similar scenes searched for, the allowable similarity may be lowered. On the contrary, when it is intended to decrease the number of similar scenes searched for, the allowable similarity may be raised. The allowable similarity is assumed to be arbitrarily set by a user.

Here, the lowering of the allowable similarity means that it is easier to search for similar scenes as much, but the similar scenes searched for in this way may include scenes having a low similarity. Therefore, in order not to search for a scene having a similarity equal to or lower than a certain degree as a similar scene, the lower limit (threshold value) of the allowable similarity is established. Accordingly, it is possible to prevent a scene having a similarity lower than the threshold value from being searched for as a similar scene.

When a similar scene of each of plural scenes is searched for, a scene having a similarity lower than the threshold value is not searched for as the similar scene. Accordingly, similar scenes of plural scenes may not be searched for. In this case, the number of similar scenes searched for is smaller than the number of original scenes. Therefore, similar content in which the similar scenes searched for are connected is equal to or shorter than the original content.

In the example shown in FIG. 8, scenes 211-1 and 211-2 are recorded in the server 162-1, scenes 211-3 to 211-5 are recorded in the server 162-2, and scenes 211-6 and 211-7 are recorded in the server 162-3.

The recording and reproducing apparatus 181 searches the scenes recorded in the servers 162 for a similar scene depending on the predetermined allowable similarity. When the similar scene is searched for, the recording and reproducing apparatus 181 records the similar scene on the recording medium 71.

On the other hand, when no similar scene is searched for as the search result based on a predetermined allowable similarity, the recording and reproducing apparatus 181 lowers the allowable similarity from the predetermined value and tries to re-search for a similar scene. Accordingly, it is possible to search for a similar scene having a low similarity but having a similarity equal to or higher than a predetermined value. When a similar scene is searched for, the recording and reproducing apparatus 181 records the similar scene on the recording medium 71.

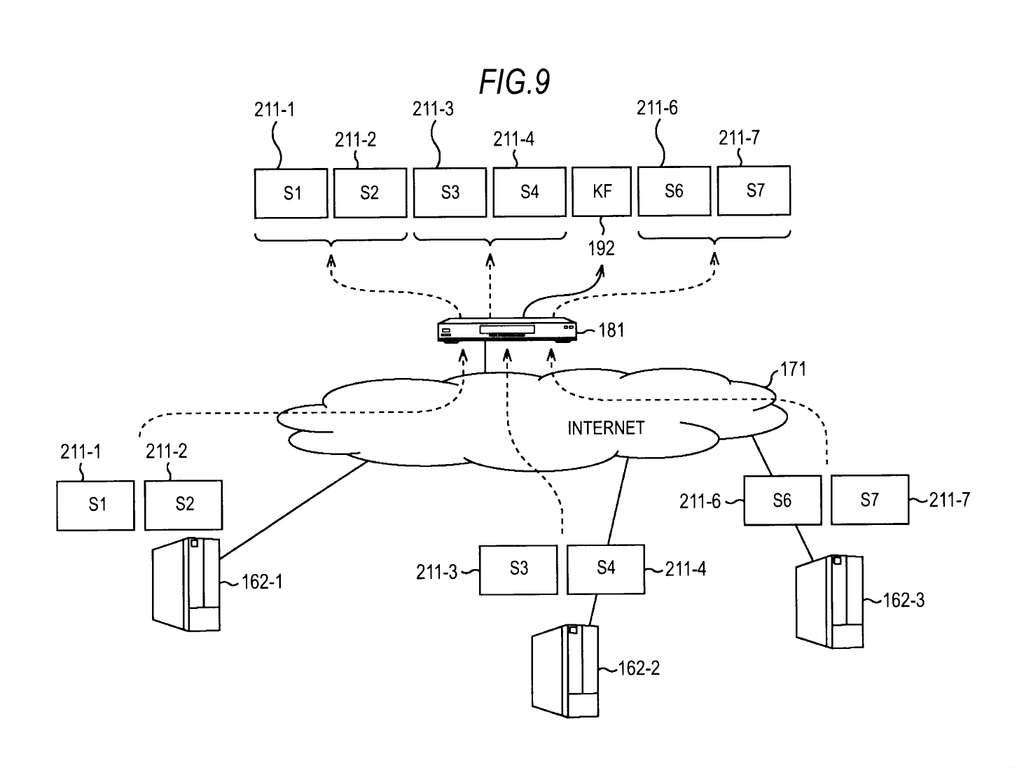

A case where it is instructed to reproduce the content 211 deleted from the recording medium 71 by the user will be described below with reference to FIG. 9.

### [Reproduction of Content]

FIG. 9 is a diagram illustrating the reproduction of the content 211.

It is assumed that the recording and reproducing apparatus 181 searches for a similar scene of each scene included in the content 211 from the scenes included in the contents recorded in the server 162 and the following result is obtained. That is, out of the scenes included in the content 211, similar scenes of the scenes 211-1 and 211-2 are recorded in the server 162-1, similar scenes of the scenes 211-3 and 211-4 are recorded in the server 162-2, and similar scenes of the scenes 211-6 and 211-7 are recorded in the server 162-3.

The recording and reproducing apparatus 181 records the plural similar scenes on the recording medium 71. The recording and reproducing apparatus 181 synthesizes new content including the plural similar scenes recorded on the recording medium 71 and the key frame 192 recorded on the recording medium 71 and reproduces the new content. Accordingly, the recording and reproducing apparatus 181 can reproduce the similar content of the content 211 deleted from the recording medium 71.

As described above, the recording and reproducing apparatus 181 can search for scenes having a high similarity to the scenes included in the content 211 and can reproduce content having a high similarity to the content 211.

The content 211 selected as content to be deleted is content having a low access frequency by a user. That is, even when the user viewed the content 211 in the past, it can be considered that there is high possibility that the user does not recall well the details at the present. Accordingly, when it is instructed to reproduce the content 211 deleted from the recording medium 72 by the user, it can be considered that the user's requirement is more satisfied by reproducing similar content similar to the content 211 than by considering the content 211 to be unreproducible.

When plural similar scene of a predetermined scene included in the content 211 can be searched for from the server 162, a similar scene having better image quality may be preferentially selected. For example, it is assumed that a similar scene of an SD (Standard Definition) image with a low definition or standard definition and a similar scene of an HD (High Definition) image with a high definition are searched for as the similar scene of a predetermined scene. In this case, the recording and reproducing apparatus 181 selects the similar scene of an HD image with a high definition and records the selected similar scene on the recording medium 71.

In the above-mentioned example, the recording and reproducing apparatus 181 records the key frame 192 of the content 211 on the recording medium 71 along with the feature quantities of the respective scenes of the content 211. However, the key frame 192 of the content 211 may not be recorded on the recording medium 71 but may be deleted. In this case, a key frame identical or similar to the deleted key frame 192 is searched for from the server 162.

In the above-mentioned embodiment, the feature quantity of each scene of the content 211 is employed as the meta data 191 capable of identifying the details of the selected content 211. However, the meta data 191 is not limited to the feature quantity. For example, when a program is employed as the content 211, the EPG information can be employed as the meta data 191. The recording and reproducing apparatus 181 can search the contents recorded in the server 162 for the similar content on the basis of the information such as a title, a broadcast time, a channel, and a broadcast region of the content 211 included in the EPG information and can reproduce the similar content.

For example, when a video imaged by a user is employed as the content 211, information such as imaging date and time and an imaging place of the video can be employed as the meta data 191. Specifically, when the content 211 is a video obtained by causing a user to image a predetermined event, the recording and reproducing apparatus 181 searches the server 162 for contents obtained by imaging the same event. The recording and reproducing apparatus 181 can search for and record similar scenes of the scenes included in the content 211 from the scenes included in the searched-for contents and can synthesize and reproduce new content including the similar scenes.

### [Functional Configuration of System Controller]

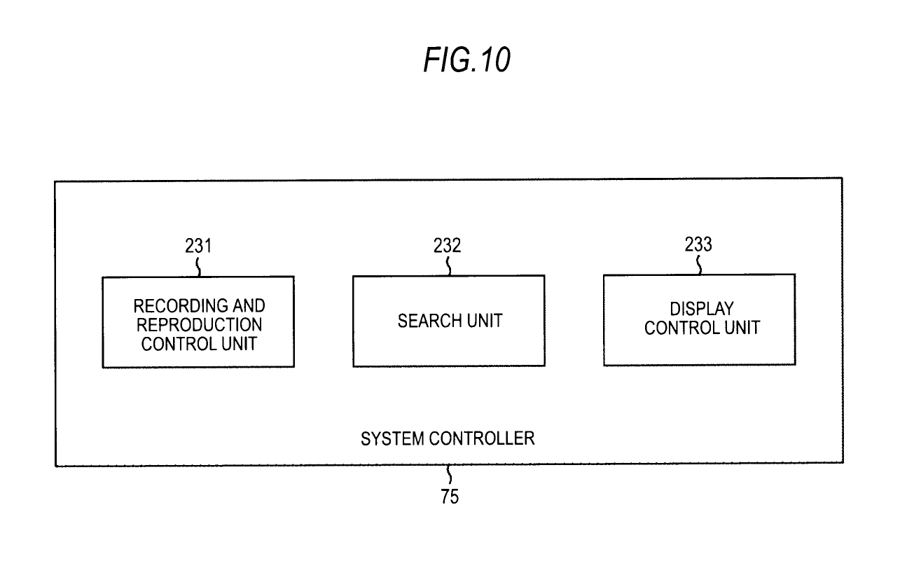

FIG. 10 is a block diagram illustrating the functional configuration of the system controller 75 of the user recording and reproducing system 161.

The system controller 75 includes a recording and reproduction control unit 231, a search unit 232, and a display control unit 233.

The recording and reproduction control unit 231 can record content on a recording medium and can read and reproduce the content from the recording medium. The recording and reproduction control unit 231 performs processes of monitoring free capacity of the recording medium 71, recording, reproducing, and deleting content, and recording a feature quantity.

The search unit 232 searches the server 162 for a similar scene of a predetermined scene of the content 211.

The display control unit 233 performs a control of displaying a warning for a user or the like on the display 32.

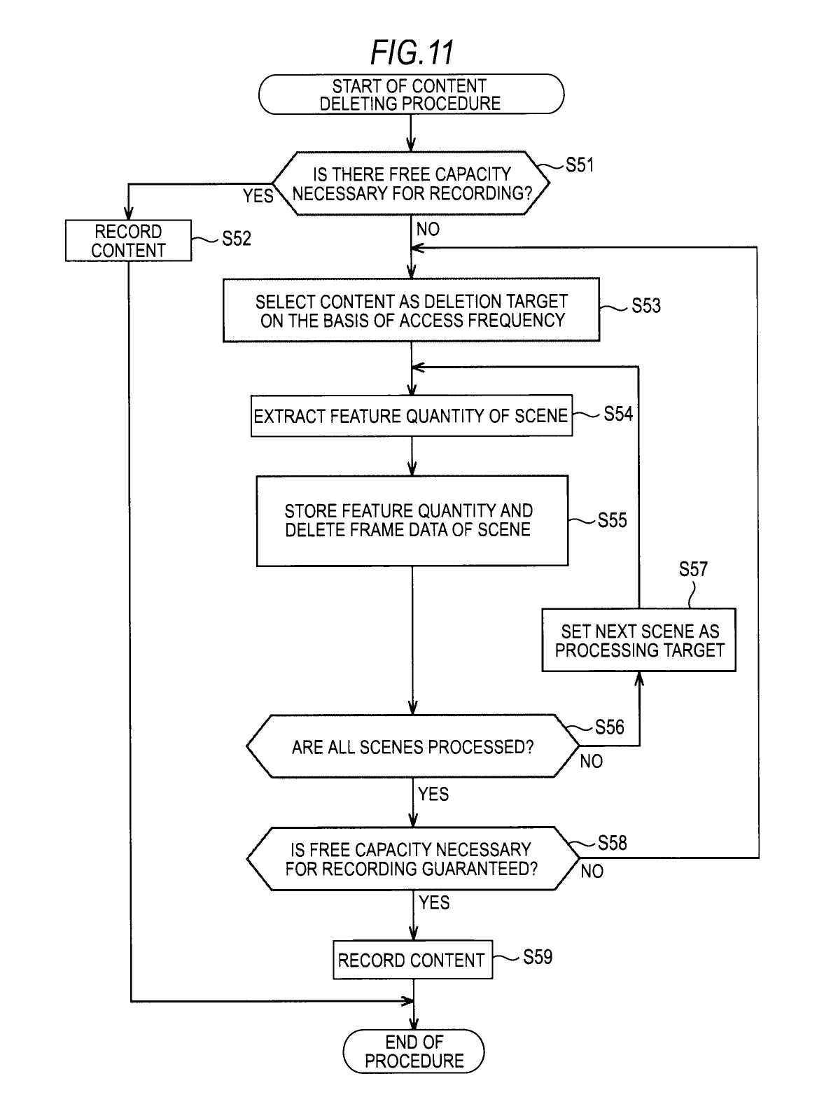

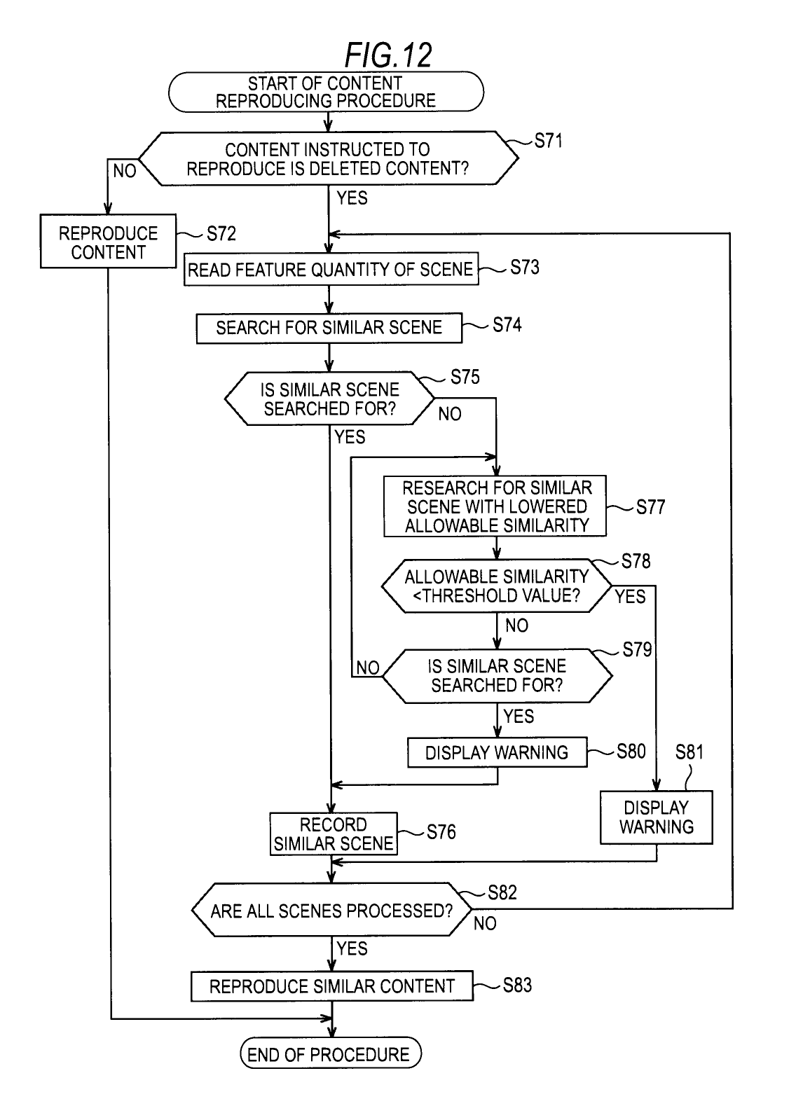

The procedure (hereinafter, referred to as content deleting procedure) of recording only the meta data 191 and deleting the content, which is described above with reference to FIG. 8, will be described below with reference to FIG. 11. The procedure (hereinafter, referred to as content reproducing procedure) of reproducing the deleted content, which is described above with reference to FIG. 9, will be described below with reference to FIG. 12. In FIGS. 11 and 12, it is assumed that the key frame 192 of the content 211 is not recorded on the recording medium 71 but is deleted.

### [Content Deleting Procedure]

FIG. 11 is a flowchart illustrating the flow of the content deleting procedure.

The content deleting procedure is started when it is instructed to record new content in response to an operation signal from the operation unit 66 having received the user's predetermined operation.

In step S51, the recording and reproduction control unit 231 determines whether free capacity necessary for recording the new content is present in the recording medium 71.

When the free capacity for recording is present in the recording medium 71, the determination result of step S51 is YES and the flow of processes goes to step S52.

In step S52, the recording and reproduction control unit 231 records the new content on the recording medium 71. That is, in this case, the new content is recorded on the recording medium 71 without any change.

Accordingly, the content deleting procedure is ended.

On the contrary, when the free capacity necessary for recording is not present in the recording medium 71, the determination result of step S51 is NO and the flow of processes goes to step S53.

In step S53, the recording and reproduction control unit 231 selects content to be deleted on the basis of an access frequency. That is, the recording and reproduction control unit 231 selects content having a low access frequency by a user as the content to be deleted out of the recorded contents. Hereinafter, it is assumed that the content 211 shown in FIG. 8 is selected as the content to be deleted.

In step S54, the recording and reproduction control unit 231 extracts the feature quantities of scenes included in the content 211. That is, the recording and reproduction control unit 231 extracts the feature quantity for each scene included in the content 211 and extracted by the video and audio feature extracting unit 65.

In step S55, the recording and reproduction control unit 231 records the feature quantity of the corresponding scene and deletes frame data constituting the corresponding scene.

In step S56, the recording and reproduction control unit 231 determines whether all the scenes included in the content 211 are processed. That is, the recording and reproduction control unit 231 records the feature quantities of all the scenes included in the content 211 and determines whether the frame data constituting the scenes of which the feature quantity is recorded is deleted.

When all the scenes are not processed yet, the determination result of step S56 is NO and the flow of processes goes to step S57.

In step S57, the recording and reproduction control unit 231 sets a next scene as a processing target. Then, the flow of processes is returned to step S54 and the subsequent processes are repeated. That is, until all the scenes are processed, the loop processes of steps S54 to S57 are repeated.

Thereafter, when all the scenes are processed, the determination result of step S56 is YES and the flow of processes goes to step S58.

In step S58, the recording and reproduction control unit 231 determines whether the free capacity necessary for recording is guaranteed in the recording medium 71. That is, the recording and reproduction control unit 231 determines whether the free capacity necessary for recording the new content is guaranteed in the recording medium 71 by recording only the feature quantities of the content 211 on the recording medium 71 and deleting the content 211.

When the free capacity necessary for recording is not guaranteed in the recording medium 71 yet, the determination result of step S58 is NO, the flow of processes is returned to step S53, and the subsequent processes are repeated. That is, until the free capacity necessary for recording the new content is guaranteed in the recording medium 71, the loop processes of steps S53 to S58 are repeated.

Thereafter, when the free capacity necessary for recording the new content is guaranteed in the recording medium 71, the determination result of step S58 is YES and the flow of processes goes to step S59.

In step S59, the recording and reproduction control unit 231 records the new content on the recording medium 71.

Accordingly, the content deleting procedure is ended.

In the example shown in FIG. 11, the criterion that the access frequency by a user is low is employed as a predetermined determination criterion for selecting an archive target. However, as described above, a determination criterion that a user's operation details on the input unit is an instruction to delete predetermined content maybe employed. That is, even when the content 211 is deleted in response to the operation signal from the operation unit 66 having received the user's predetermined operation, only the feature quantities of the content 211 are recorded on the recording medium 71 and the content 211 is deleted.

In this case, the procedure shown in FIG. 11 is started from step S53 and the content instructed to delete in response to the operation signal from the operation unit 66 having received the user's predetermined operation in step S53 is set as the content to be deleted. Thereafter, as described above, the processes of steps S54 to S56 are performed. When the determination result of step S56 is YES, the flow of processes is ended.

As the result of performing the above-mentioned content deleting procedure, since only the feature quantities of the content to be deleted are recorded on the recording medium 71 and the content is deleted, the free capacity necessary for recording the new content is guaranteed.

### [Content Reproducing Procedure]

FIG. 12 is a flowchart illustrating the flow of the content reproducing procedure.

The content reproducing procedure is started when it is instructed to reproduce content in response to an operation signal from the operation unit 66 having received a user's predetermined operation.

In step S71, the recording and reproduction control unit 231 determines whether the content instructed to reproduce is deleted content.

When the content instructed to reproduce is not deleted content, the determination result of step S71 is No and the flow of processes goes to step S72.

In step S72, the recording and reproduction control unit 231 reproduces the content instructed to reproduce. When the content instructed to reproduce is not deleted content, the content is recorded on the recording medium 71. Accordingly, the recording and reproduction control unit 231 reads and reproduces the content recorded on the recording medium 71.

Accordingly, the content reproducing procedure is ended.

On the contrary, when the content instructed to reproduce is the deleted content 211, the determination result of step S71 is YES and the flow of processes goes to step S73. Hereinafter, it is assumed that the deleted content is the content 211 deleted through the procedure shown in FIG. 11.

In step S73, the recording and reproducing control unit 231 reads the feature quantity of a predetermined scene of the content 211. That is, the recording and reproducing control unit 231 reads the feature quantity of the predetermined scene of the content 211 recorded on the recording medium 71 through the content deleting procedure shown in FIG. 11.

In step S74, the search unit 232 searches a similar scene of the predetermined scene of the content 211. That is, the search unit 232 searches for the similar scene from the scenes included in plural contents recorded in the server 162 via the Internet 171 depending on a predetermined allowable similarity.

In step S75, the search unit 232 determines whether the similar scene of the predetermined scene of the content 211 is searched for.

When the similar scene of the predetermined scene of the content 211 is not searched for, the determination result of step S75 is NO and the flow of processes goes to step S77. The process of step S77 and the subsequent processes will be described later.

On the contrary, when the similar scene of the predetermined scene of the content 211 is searched for, the determination result of step S75 is YES and the flow of processes goes to step S76.

In step S76, the recording and reproduction control unit 231 records the similar scene of the predetermined scene of the content 211 on the recording medium 71.

When the similar scene of the predetermined scene of the content 211 is recorded on the recording medium 71, the flow of processes goes to step S82. The process of step S82 and the subsequent processes thereof will be described later.

On the other hand, when the similar scene of the predetermined scene of the content 211 is not searched for, the determination result of step S75 is NO and the flow of processes goes to step S77.

In step S77, the search unit 232 lowers the allowable similarity and re-searches for the similar scene. That is, the search unit 232 tries to search for a scene having a feature quantity with a lower similarity to the feature quantity of the predetermined scene than the similar scene searched for in step S74.

In step S78, the search unit 232 determines whether the allowable similarity is less than the threshold value.

When the allowable similarity is less than the threshold value, the determination result of step S78 is YES and the flow of processes goes to step S81. The process of step S81 and the subsequent processes thereof will be described later.

On the contrary, when the allowable similarity is equal to or more than the threshold value, the determination result of step S78 is NO and the flow of processes goes to step S79.

In step S79, the search unit 232 determines whether a similar scene of the predetermined scene of the content 211 is searched for.

When a similar scene of the predetermined scene of the content 211 is searched for, the determination result of step S79 is YES and the flow of processes goes to step S80.

In step S80, the display control unit 233 displays a warning. That is, the similar scene searched for in step S79 is a scene searched for after the allowable similarity is lowered and is a scene having a low similarity to the feature quantity of the predetermined scene of the content 211. Therefore, the display control unit 233 performs a control of displaying a warning indicating that a scene having a low similarity to the scene included in the content 211 is included on the display 32.

When the warning is displayed, the flow of processes goes to step S76.

In step S76, the recording and reproduction control unit 231 records the similar scene of the predetermined scene of the content 211 on the recording medium 71. That is, the recording and reproduction control unit 231 records the similar scene searched for after lowering the allowable similarity on the recording medium 71.

When the similar scene of the predetermined scene of the content 211 is recorded on the recording medium 71, the flow of processes goes to step S82. The process of step S82 and the subsequent processes thereof will be described later.

On the other hand, when a similar scene of the predetermined scene of the content 211 is not searched for, the determination result of step S79 is NO, the flow of processes is returned to step S77, and the subsequent processes thereof are repeated. That is, until a similar scene of the predetermined scene of the content 211 is searched for in the state where the allowable similarity is equal to or more than the threshold value, the loop processes of steps S77 to S79 are repeated.

Thereafter, when the allowable similarity is lower than the threshold value, the determination result of step S78 is YES and the flow of processes goes to step S81.

In step S81, the display control unit 233 displays a warning. That is, when the allowable similarity is lower than the threshold value, a similar scene of the predetermined scene is not searched for. Therefore, the display control unit 233 displays a warning indicating that the similar content to be reproduced is content shorter than the content 211.

In step S82, the recording and reproduction control unit 231 determines whether all the scenes included in the content 211 are processed. That is, the recording and reproduction control unit 231 determines whether the similar scenes of all the scenes included in the content 211 are searched for.

When all the scenes are not processed yet, the determination result of step S82 is NO, the flow of processes is returned to step S73, and the subsequent processes are repeated. That is, until all the scenes are processed, the loop processes of steps S73 to S82 are repeated.

Thereafter, when all the scenes are processed, the determination result of step S82 is YES and the flow of processes goes to step S83.

In step S83, the recording and reproduction control unit 231 reproduces the similar content. That is, the recording and reproduction control unit 231 syntheses and reproduces new content including plural similar scenes recorded on the recording medium 71 as the search result. That is, the similar content of the content 211 deleted from the recording medium 71 is reproduced.

Accordingly, the content reproducing procedure is ended.

Through the content reproducing procedure, the user can view content having a high similarity to the content deleted from the recording medium 71 to guarantee the recording capacity. The user can view content having a high similarity to the content deleted by oneself.

### 3. Third Embodiment

In the second embodiment, the free capacity necessary for recording is guaranteed by recording only the meta data capable of identifying the details of the recorded content on the recording medium and deleting the content itself. In this case, it is necessary for the server, for example, which is a commercially-available server, to record a large number of contents, so that the user recording and reproducing system can search for the similar scenes of the scenes included in the deleted content. However, instead of recording a large number of contents in the server, the user recording and reproducing system may search for the similar content from the contents recorded in another user recording and reproducing system.

### [Configuration of Content Managing System]

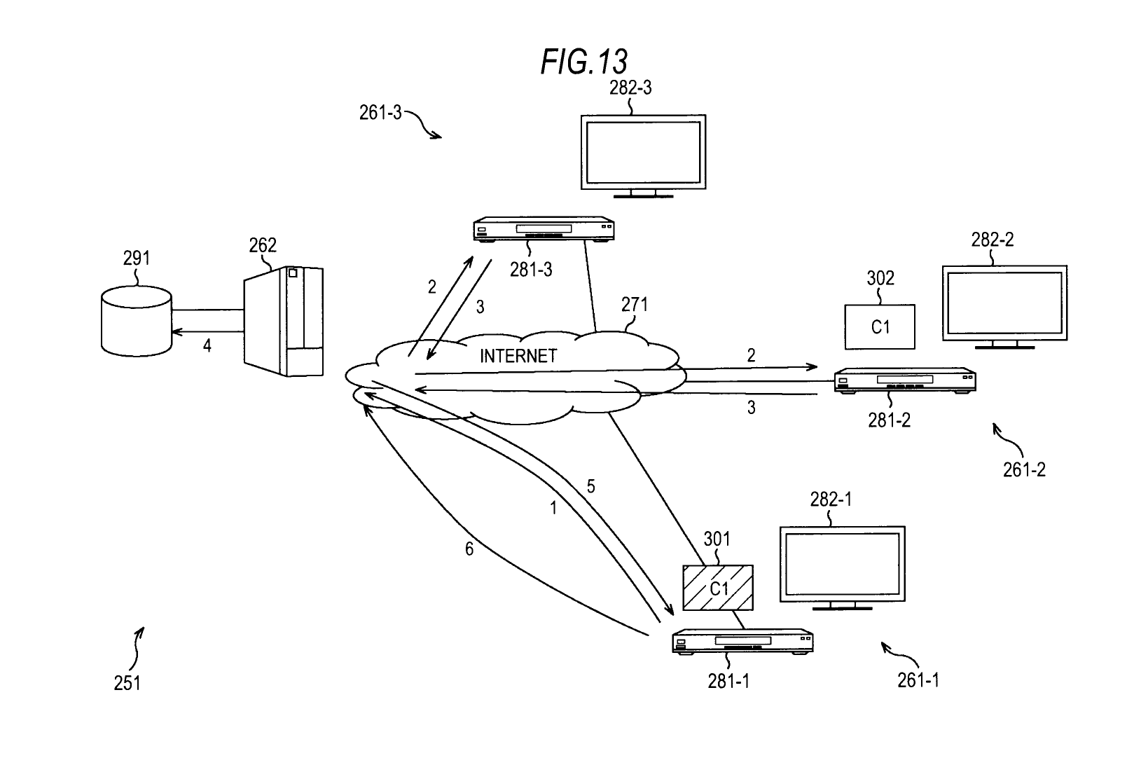

FIG. 13 is a block diagram illustrating the configuration of content managing system according to a third embodiment of the present disclosure.

The content managing system 251 shown in FIG. 13 has a configuration in which user recording and reproducing systems 261-1 to 261-N (where N is an integer equal to or greater than 2 and is 3 in the example shown in FIG. 13) and a server 262 are connected to each other via the Internet 271. The respective user recording and reproducing systems 261-i (where i is an integer of 1 to 3) include a recording and reproducing apparatus 281-i and a display 282-i. The server 262 is connected directly to a feature quantity database 291 via a cable or the like.

Hereinafter, when it is not necessary to individually distinguish the user recording and reproducing systems 261-1 to 261-3, they are referred to as the user recording and reproducing systems 261. The same is true of the other elements.

The basic configurations of the user recording and reproducing system 261 and the server 262 are the same as the configurations of the user recording and reproducing system shown in FIG. 3 and the server 12 shown in FIG. 4. Accordingly, the configurations of the user recording and reproducing system 11 shown in FIG. 3 and the server 12 shown in FIG. 4 are incorporated therein by reference as the configurations of the user recording and reproducing system 261 and the servers 262 shown in FIG. 13. The arrows in FIG. 13 represent the flow of processes and numerals K (where K is an integer of 1 to 6) attached to the arrows represent the order of the flow of processes. Therefore, an arrow having a numeral K attached thereto is referred to as the K-th arrow and the flow of processes will be sequentially described.

The recording and reproducing apparatus 281-1 of the user recording and reproducing system 261-1 determines whether the free capacity of the recording medium 71 is sufficient for recording new content. When determining that the free capacity necessary for recording the new content on the recording medium 71 is not sufficient, the recording and reproducing apparatus 281-1 selects content having a low access frequency by the user out of the contents recorded on the recording medium 71 as content to be deleted. In FIG. 13, it is assumed that the content 301 is selected as content to be deleted.

As represented by the first arrow, the recording and reproducing apparatus 281-1 transmits meta data capable of identifying the details of the content 301 to the server 262 before deleting the content 301 to be deleted. In this embodiment, the feature quantities of the content 301 extracted by the video and audio feature extracting unit 65 are employed as the meta data.

Then, as represented by the second arrow, the server 262 transmits the feature quantities of the content 301 received from the recording and reproducing apparatus 281-1 to the user recording and reproducing systems 261-2 and 261-3. The server 262 inquires the user recording and reproducing systems 261-2 and 261-3 whether similar content of the content 301 is present.

As represented by the third arrow, the user recording and reproducing systems 261-2 and 261-3 respond to the inquiry. That is, the user recording and reproducing systems 261-2 and 261-3 determine whether the similar content of the content 301 is recorded in their recording and reproducing apparatuses 281-2 and 281-3. The user recording and reproducing systems 261-2 and 261-3 transmit the inquiry result of presence or absence of the similar content.

Here, it is assumed that the user recording and reproducing system 261-3 transmits the inquiry result of absence of the similar content. That is, the similar content of the content 301 is not recorded in the recording and reproducing apparatus 281-3, or is deleted from the recording and reproducing apparatus 281-3 since the reproduction frequency thereof is low or the user deletes the content.

On the other hand, it is assumed that the user recording and reproducing system 261-2 transmits the inquiry result of presence of the similar content. That is, similar content 302 of the content 301 is recorded in the recording and reproducing apparatus 281-2 and remains recorded in the recording and reproducing apparatus 281-2 since the reproduction frequency of the similar content 302 is not low.

Then, as represented by the fourth arrow, the server 262 records information of the recording and reproducing apparatus 281-2 of the user recording and reproducing system 261-2 having transmitted the inquiry result of presence of the similar content and the feature quantities of the similar content 302 on the feature quantity database 291. The information of the recording and reproducing apparatus 281-2 has only to be information capable of identifying the recording and reproducing apparatus 281-2 and may be, for example, user information of the recording and reproducing apparatus 281-2.

As represented by the fifth arrow, the server 262 transmits the result on whether similar content of the content 301 is recorded in a recording and reproducing apparatus 281 of a different user recording and reproducing system 261 to the user recording and reproducing system 261-1. In FIG. 13, the similar content 302 is recorded in the user recording and reproducing system 261-2. Accordingly, the server 262 transmits the result that the similar content of the content 301 is recorded in the recording and reproducing apparatus 281 of a different user recording and reproducing system 261.

When receiving the result that the similar content is recorded in the recording and reproducing apparatus 281 of the different user recording and reproducing system 261, the recording and reproducing apparatus 281-1 of the user recording and reproducing system 261-1 records the feature quantities of the content 301 and then deletes the content 301. The recording and reproducing apparatus 281-1 also records the feature quantity for each scene of the content 301.

On the contrary, when receiving the result that similar content is not recorded in the recording and reproducing apparatuses 281 of the different user recording and reproducing systems 261, the recording and reproducing apparatus 281-1 of the user recording and reproducing system 261-1 performs the following processes.

That is, the recording and reproducing apparatus 281-1 records the feature quantities of the content 301, performs a predetermined compressing and encoding process on the content 301, and transmits the resultant data to the server 262. That is, the recording and reproducing apparatus 281-1 performs the archive process on the content 301. As a result, the content 301 is deleted from the recording medium 71 of the recording and reproducing apparatus 281-1 and is recorded on the recording medium 93 of the server 262. At this time, the server 262 also records the feature quantities of the content 301. The recording and reproducing apparatus 281-1 also records the feature quantity of each scene of the content 301, when recording the feature quantities of the content 301.

That is, in the content managing system 251, plural contents are distributed and recorded in plural user recording and reproducing systems 261. Accordingly, when similar content 302 of the content 301 is recorded in different user recording and reproducing systems 261, the user recording and reproducing system 261-1 can leave only the feature quantities of the content 301 and can delete the content 301 from the recording medium 71. On the contrary, when the similar content 302 of the content 301 is not recorded in the different user recording and reproducing systems 261, the user recording and reproducing system 261-1 leaves the feature quantities of the content 301, performs the archive process on the content 301, and records the content 301 in the server 262. Accordingly, the user recording and reproducing system 261-1 can delete the content 301 from the recording medium 71.

Although not shown in the drawing, plural servers 162 shown in FIG. 8 are connected to the Internet 271. As described above, the servers 162 are commercially-available servers and record a large number of contents.

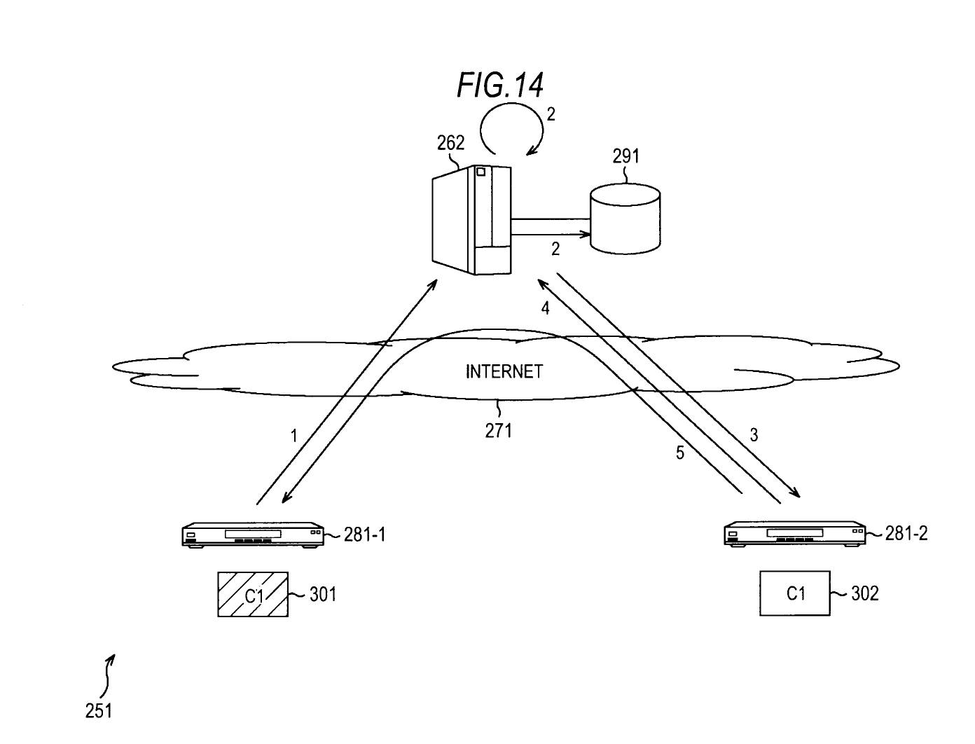

A case where the recording and reproducing apparatus 281 reproduces the content 301 deleted from the recording medium 71 will be described below with reference to FIG. 14.

### [Reproduction of Content]

FIG. 14 is a diagram illustrating the reproduction of the content 301.

In FIG. 14, the recording and reproducing apparatus 281-1 of the user recording and reproducing system 261-1, the recording and reproducing apparatus 281-2 of the user recording and reproducing system 261-2, and the server 262 shown in FIG. 13 are shown. The recording and reproducing apparatuses 281-1 and 281-2 and the server 262 are connected to each other via the Internet 271. The arrows in the drawing represent the same flow of processes as in FIG. 13.

As represented by the first arrow, when it is instructed to reproduce the deleted content 301, the recording and reproducing apparatus 281-1 transmits the feature quantities of the content 301 recorded on the recording medium 71 to the server 262.

Then, as represented by the second arrow, the server 262 checks whether the compressed and encoded content 301 is recorded on the recording medium 93 on the basis of the received feature quantities of the content 301. When the compressed and encoded content 301 is not recorded as the check result, the server 262 checks whether similar content is recorded in different recording and reproducing apparatuses 281. That is, the server 262 searches the feature quantity database 291 for information of the recording and reproducing apparatus 281 in which the similar content is recorded.

When the compressed and encoded content 301 is recorded on the recording medium 93, the server 262 transmits the compressed and encoded content 301 to the recording and reproducing apparatus 281-1. However, in this case, it is assumed that the compressed and encoded content 301 is not recorded on the recording medium 93 and information of the recording and reproducing apparatus 281-2 in which similar content is recorded is searched for from the feature quantity database 291.

Then, as represented by the third arrow, the server 262 inquires the recording and reproducing apparatus 281-2 whether the similar content 302 can be transmitted.

Then, as represented by the fourth arrow, the recording and reproducing apparatus 281-2 transmits the result of enabled or disabled transmission to the server 262.

When the result of enabled transmission is transmitted to the server 262, the recording and reproducing apparatus 281-2 transmits the similar content 302 to the recording and reproducing apparatus 281-1 via the server 262, as represented by the fifth arrow. The recording and reproducing apparatus 281-2 may not transmit the similar content 302 to the recording and reproducing apparatus 281-1 via the server 262, but may transmit the similar content directly to the recording and reproducing apparatus 281-1.

On the contrary, not shown in the drawing, when the result of disabled transmission is transmitted to the server 262, the recording and reproducing apparatus 281-1 searches the plural servers 162 which are commercially-available servers for a similar scene for each scene included in the content 301 in the same way as described with reference to FIG. 12.

In the above-mentioned example, the feature quantities of the content 301 are employed as the meta data capable of identifying the details of the deleted content 301. However, the meta data is not limited to the feature quantities. When a broadcast program is employed as the content 301, for example, the EPG information may be employed as the meta data. When a video imaged by a user is employed as the content 301, information such as imaging date and time and image places may be employed as the meta data.

As described above, in the content managing system 251, plural contents are distributed and recorded in plural user recording and reproducing systems 261. Accordingly, it is not necessary for the server 262 to record a large number of contents. Since different user recording and reproducing systems 261 instead of the server 262 may transmit the contents to the user recording and reproducing system 261-1, the server 262 does not have to respond to all a large number of requests for transmission. Therefore, it is possible to suppress the construction cost and the operating cost of the server 262.

### [Functional Configuration of Management Unit]

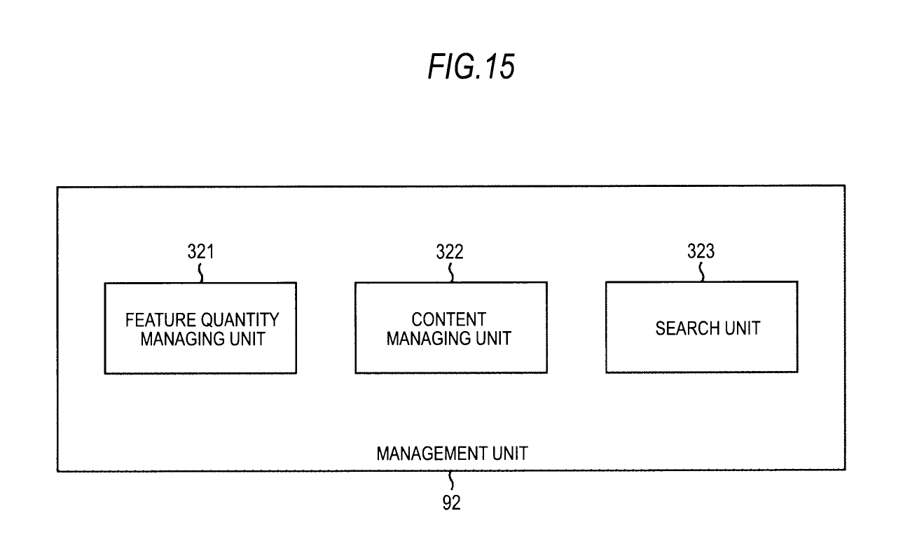

FIG. 15 is a block diagram illustrating the functional configuration of the management unit 92 of the server 262.

The management unit 92 includes a feature quantity managing unit 321, content managing unit 322, and a search unit 323.

The feature quantity managing unit 321 transmits and receives content and feature quantities for each scene of the content to and from the user recording and reproducing system 261. The feature quantity managing unit 321 inquires the user recording and reproducing system 261 of presence or absence of similar content and detects the recording and reproducing apparatus 281 having similar content.

The content managing unit 322 transmits and receives content to and from the user recording and reproducing system 261. The content managing unit 322 inquires the user recording and reproducing system 261 whether similar content can be transmitted and manages the content.

The search unit 323 searches for the recording and reproducing apparatus 281 in which the compressed and encoded content 301 and the similar content are recorded on the basis of the content and the feature quantities for each scene of the content.

The functional configuration of the system controller 75 of the user recording and reproducing system 261 is the same as shown in FIG. 10.

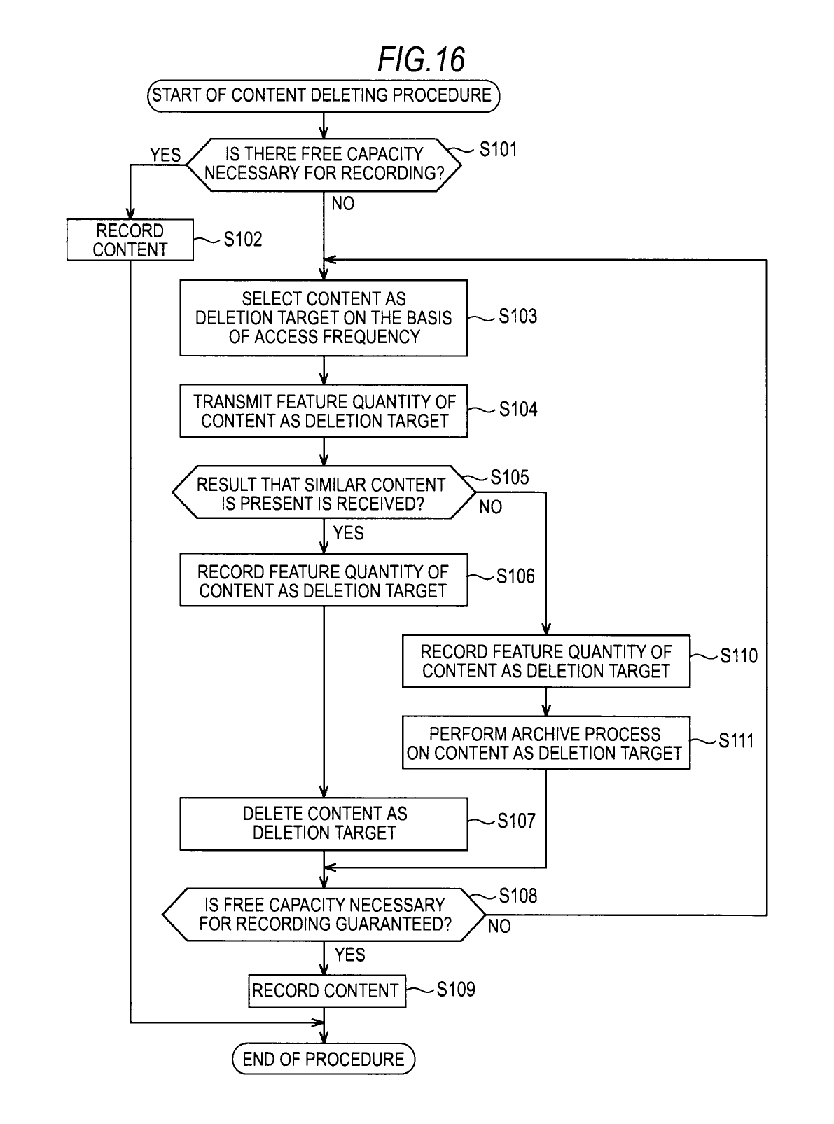

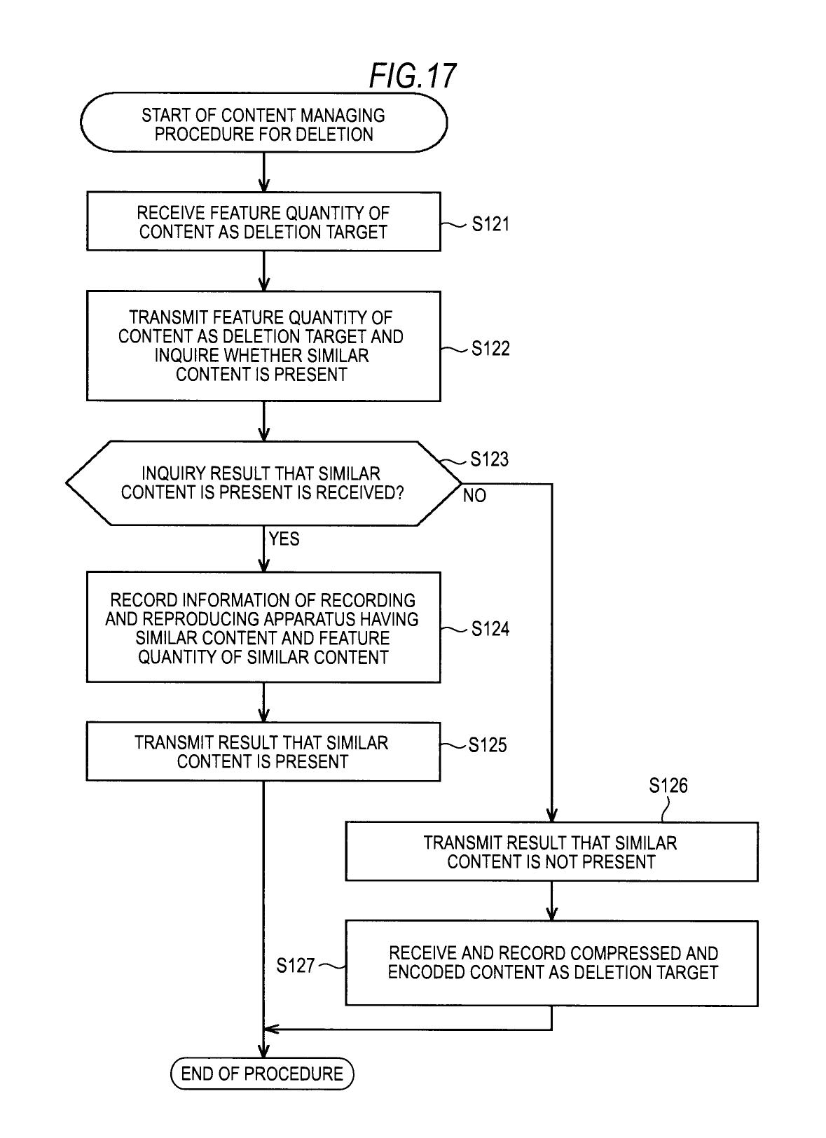

The procedure (hereinafter, referred to as content deleting procedure) of recording only the meta data and deleting the content 301, which is described above with reference to FIG. 13 and is performed by the user recording and reproducing system 261-1, will be described below with reference to FIG. 16. The procedure (hereinafter, referred to as content managing procedure for deletion) performed at that time by the server 262 will be described below with reference to FIG. 17.

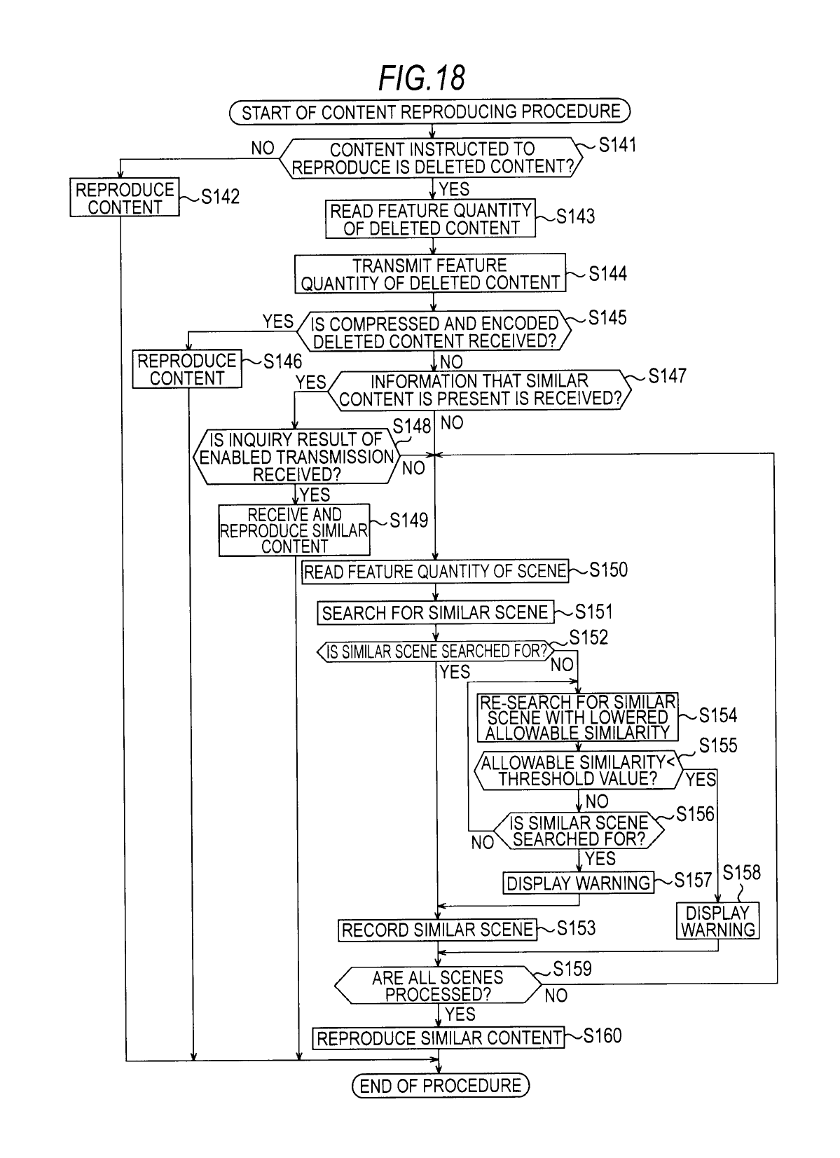

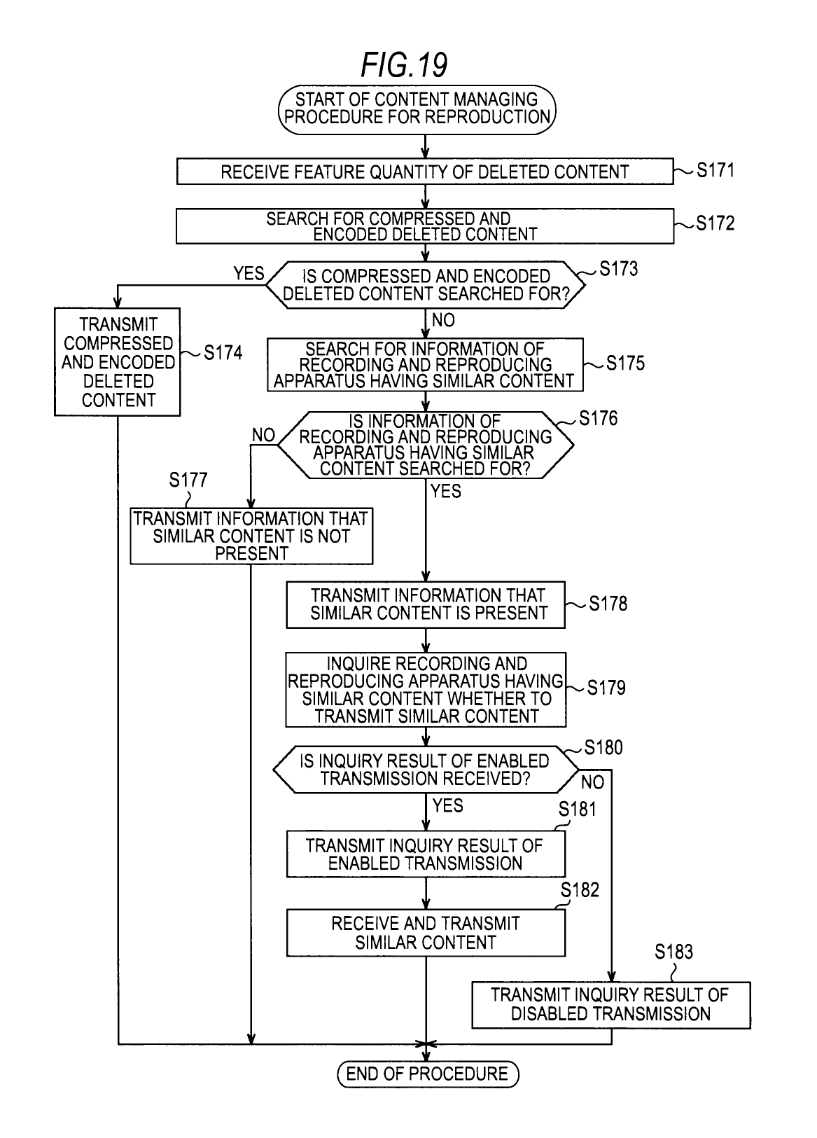

The procedure (hereinafter, referred to as content reproducing procedure) of reproducing the deleted content 301, which is described above with reference to FIG. 14 and is performed by the user recording and reproducing system 261-1, will be described below with reference to FIG. 18. The procedure (hereinafter, referred to as content managing procedure for reproduction) performed at that time by the server 262 will be described below with reference to FIG. 19.

### [Content Deleting Procedure]

FIG. 16 is a flowchart illustrating the flow of the content deleting procedure performed by the user recording and reproducing system 261-1 and FIG. 17 is a flowchart illustrating the flow of the content managing procedure for deletion, which is performed by the server 262.

The content deleting procedure shown in FIG. 16 is started when it is instructed to record new content in response to an operation signal from the operation unit 66 having received a predetermined operation from a user.

In step S101, the recording and reproduction control unit 231 of the user recording and reproducing system 261-1 determines whether free capacity necessary for recording the new content is present in the recording medium 71.

When the free capacity necessary for recording is present in the recording medium 71, the determination result of step S101 is YES and the flow of processes goes to step S102.

In step S102, the recording and reproduction control unit 231 records the new content on the recording medium 71. That is, in this case, the new content is recorded on the recording medium 71 without any change.

Accordingly, the content deleting procedure is ended.

On the contrary, when the free capacity necessary for recording is not present in the recording medium 71, the determination result of step S101 is NO and the flow of processes goes to step S103.

In step S103, the recording and reproduction control unit 231 selects content to be deleted on the basis of an access frequency. That is, the recording and reproduction control unit 231 selects content having a low access frequency by a user as the content to be deleted out of the recorded contents. Hereinafter, it is assumed that the content 301 shown in FIG. 13 is selected as the content to be deleted.

In step S104, the recording and reproduction control unit 231 transmits the feature quantities of the content 301 to be deleted to the server 262. That is, the recording and reproduction control unit 231 transmits the feature quantities of the content 301 extracted by the video and audio feature extracting unit 65 to the server 262. The process of step S105 and the subsequent processes thereof will be described later.

In step S121 shown in FIG. 17, the feature quantity managing unit 321 of the server 262 receives the feature quantities of the content 301 to be deleted, which is transmitted from the recording and reproduction control unit 231.

In step S122, the feature quantity managing unit 321 transmits the feature quantities of the content to be deleted to the user recording and reproducing systems 261-2 and 261-3 and inquires them of presence or absence of similar content. That is, the feature quantity managing unit 321 tries to search for the user recording and reproducing system 261 in which similar content is recorded.

In step S123, the feature quantity managing unit 321 determines whether the inquiry result of presence of similar content is received.

When the inquiry result of presence of similar content is not received, that is, when similar content is not recorded in any of the recording and reproducing apparatuses 281-2 and 281-3 of the user recording and reproducing systems 261-2 and 261-3, the determination result of step S123 is NO and the flow of processes goes to step S126. The process of step S126 and the subsequent processes will be described later.

On the contrary, when the inquiry result of presence of similar content is received, that is, when the user recording and reproducing system 261 in which similar content is recorded is searched for, the determination result of step S123 is YES and the flow of processes goes to step S124. In this case, it is assumed that the similar content 302 is recorded in the recording and reproducing apparatus 281-2 of the user recording and reproducing system 261-2 and the recording and reproducing apparatus 281-2 transmits the inquiry result of presence of similar content.

In step S124, the feature quantity managing unit 321 records the information of the recording and reproducing apparatus 281-2 having the similar content 302 and the feature quantities of the similar content 302 in the feature quantity database 291.

In step S125, the feature quantity managing unit 321 transmits the result of presence of similar content to the user recording and reproducing system 261-1. Accordingly, the content managing procedure for deletion is ended.

In step S105 shown in FIG. 16, the recording and reproduction control unit 231 of the user recording and reproducing system 261-1 determines whether the result of presence of similar content is received.

In this case, since the result of presence of similar content is transmitted in step S125 shown in FIG. 17, the determination result of step S105 is YES and the flow of processes goes to step S106.

In step S106, the recording and reproduction control unit 231 records the feature quantities of the content 301 to be deleted on the recording medium 71. The recording and reproduction control unit 231 also records the feature quantity for each scene of the content 301 to be deleted.

In step S107, the recording and reproduction control unit 231 deletes the content 301 to be deleted. That is, the content 301 to be deleted is deleted from the recording medium 71.

In step S108, the recording and reproduction control unit 231 determines whether the free capacity necessary for recording is guaranteed in the recording medium 71.

When the free capacity necessary for recording is not guaranteed in the recording medium 71 yet, the determination result of step S108 is NO, the flow of processes is returned to step S103, and the subsequent processes thereof are repeated. That is, until the free capacity necessary for recording new content is guaranteed in the recording medium 71, the loop processes of steps S103 to S108 are repeated.

Thereafter, when the free capacity necessary for recording new content is guaranteed in the recording medium 71, the determination result of step S108 is YES and the flow of processes goes to step S109.

In step S109, the recording and reproduction control unit 231 records the new content on the recording medium 71.

Accordingly, the content deleting procedure is ended.

On the other hand, when the inquiry result of presence of similar content is not received, the determination result of step S123 shown in FIG. 17 is NO and the flow of processes goes to step S126.

In step S126, the feature quantity managing unit 321 transmits the result of absence of similar content to the user recording and reproducing system 261-1. The process of step S127 and the subsequent processes thereof will be described later.

In step S105 shown in FIG. 16, the recording and reproduction control unit 231 of the user recording and reproducing system 261-1 determines whether the result of presence of similar content is received.

In this case, since the result of absence of similar content is transmitted in step S126 shown in FIG. 17, the determination result of step S105 is NO and the flow of processes goes to step S110.

In step S110, the recording and reproduction control unit 231 records the feature quantities of the content 301 to be deleted. The recording and reproduction control unit 231 also records the feature quantity for each scene of the content 301 to be deleted.

In step S111, the recording and reproduction control unit 231 performs the archive process on the content 301 to be deleted. That is, the recording and reproduction control unit 231 performs a predetermined compressing and encoding process on the content 301 to be deleted and transmits the resultant to the server 262. As a result, the content 301 is deleted from the recording medium 71.

Thereafter, the flow of processes goes to step S108. The process of step S108 and the subsequent processes thereof are repeated and thus are not described.

Accordingly, the content deleting procedure is ended.

When the predetermined compressing and encoding process is performed on the content 301 to be deleted in step S111, the compressed and encoded content 301 is transmitted to the server 262.

In step S127 shown in FIG. 17, the content managing unit 322 receives the compressed and encoded content 301 to be deleted and records the received content on the recording medium 93 thereof.

Accordingly, the content managing procedure for deletion is ended.

In the example shown in FIG. 16, the criterion that the access frequency by a user is low is employed as a predetermined determination criterion for selecting an archive target. However, as described above, a determination criterion that user's operation details on the input unit are an instruction to delete predetermined content may be employed. That is, even when the content 301 is deleted in response to the operation signal from the operation unit 66 having received the user's predetermined operation, the archive process is performed on the content 301.

As the result of performing the above-mentioned content deleting procedure, when the similar content 302 of the content 301 is recorded in a different user recording and reproducing system 261, only the feature quantities of the content 301 are recorded and the content 301 is deleted from the recording medium 71. On the contrary, when the similar content 302 of the content 301 is not recorded in any different user recording and reproducing system 261, the feature quantities of the content 301 are recorded and the archive process is performed on the content 301. As a result, the content 301 is deleted from the recording medium 71.

### [Content Reproducing Procedure]

FIG. 18 is a flowchart illustrating the flow of the content reproducing procedure performed by the user recording and reproducing system 261-1 and FIG. 19 is a flowchart illustrating the flow of the content managing procedure for reproduction, which is performed by the server 262.

The content reproducing procedure is started when it is instructed to reproduce content in response to an operation signal from the operation unit 66 having received a user's predetermined operation.

In step S141, the recording and reproduction control unit 231 determines whether the content instructed to reproduce is deleted content.

When the content instructed to reproduce is not deleted content, the determination result of step S141 is No and the flow of processes goes to step S142.

In step S142, the recording and reproduction control unit 231 reproduces the content instructed to reproduce. When the content instructed to reproduce is not deleted content, the content is recorded on the recording medium 71. Accordingly, the recording and reproduction control unit 231 reads and reproduces the content recorded on the recording medium 71.

Accordingly, the content reproducing procedure is ended.

On the contrary, when the content instructed to reproduce is the deleted content, the determination result of step S141 is YES and the flow of processes goes to step S143. Hereinafter, it is assumed that the deleted content instructed to reproduce is the content 301 deleted from the recording medium 71 through the content deleting procedure shown in FIG. 16.

In step S143, the recording and reproduction control unit 231 reads the feature quantities of the deleted content 301. That is, the recording and reproduction control unit 231 reads the feature quantities of the content 301 recorded on the recording medium 71 in step S106 or S110 of the content deleting procedure shown in FIG. 16.

In step S144, the recording and reproduction control unit 231 transmits the feature quantities of the deleted content 301 to the server 262. The process of step S145 and the subsequent processes thereof will be described later.

In step S171 shown in FIG. 19, the feature quantity managing unit 321 of the server 262 receives the feature quantities of the deleted content 301.

In step S172, the search unit 323 searches the recording medium 93 for the compressed and encoded deleted content 301. That is, the search unit 323 searches for the compressed and encoded deleted content 301 recorded in step S127 of the content managing procedure for deletion shown in FIG. 17 on the basis of the feature quantities of the deleted content 301.

In step S173, the search unit 323 determines whether the compressed and encoded deleted content 301 is searched for.

When the compressed and encoded deleted content 301 is not searched for, the determination result of step S173 is NO and the flow of processes goes to step S175. The processes of step S175 and the subsequent processes thereof will be described later.

On the contrary, when the compressed and encoded deleted content 301 is searched for, the determination result of step S173 is YES and the flow of processes goes to step S174.

In step S174, the content managing unit 322 transmits the compressed and encoded deleted content 301 to the user recording and reproducing system 261-1. Accordingly, the content managing procedure for reproduction is ended.

On the other hand, when the compressed and encoded deleted content 301 is not searched for, the determination result of step S173 is NO and the flow of processes goes to step S175.

In step S175, the search unit 323 searches the feature quantity database 291 for the information of the recording and reproducing apparatus 281 having similar content. That is, the search unit 323 searches for the information of the recording and reproducing apparatus 281 of the user recording and reproducing system 261 having similar content, which is recorded in step S124 of the content managing procedure for deletion shown in FIG. 17.

In step S176, the search unit 323 determines whether the information of the recording and reproducing apparatus 281 having similar content is searched for.

When the information of the recording and reproducing apparatus 281 having similar content is searched for, the determination result of step S176 is YES and the flow of processes goes to step S178. In this case, it is assumed that the information of the recording and reproducing apparatus 281-2 of the user recording and reproducing system 261-2 having similar content recorded therein is searched for. The process of step S176 and the subsequent processes thereof will be described later.

On the contrary, when the information of the recording and reproducing apparatus 281 having similar content is not searched for, the determination result of step S176 is NO and the flow of processes goes to step S177.

In step S177, the content managing unit 322 transmits the information of absence of similar content to the user recording and reproducing system 261-1. Accordingly, the content managing procedure for reproduction is ended.

On the other hand, when the information of the recording and reproducing apparatus 281 having the similar content 302 is searched for, the determination result of step S176 is YES and the flow of processes goes to step S178.

In step S178, the content managing unit 322 transmits the information of presence of similar content to the user recording and reproducing system 261-1.

In step S179, the content managing unit 322 inquires the recording and reproducing apparatus 281-2 of the user recording and reproducing system 261-2 having the similar content 302 whether the similar content 302 can be transmitted.

In step S180, the content managing unit 322 determines whether the inquiry result of enabled transmission of the similar content 302 is received.

When the inquiry result of enabled transmission is received, the determination result of step S180 is YES and the flow of processes goes to step S181. The process of step S181 and the subsequent processes thereof will be described later.

On the contrary, when the inquiry result of enabled transmission is not received, the determination result of step S180 is NO and the flow of processes goes to step S183.

In step S183, the content managing unit 322 transmits the inquiry result of disabled transmission to the user recording and reproducing system 261-1. Accordingly, the content managing procedure for reproduction is ended.

On the other hand, when the inquiry result of enabled transmission is received, the determination result of step S180 is YES and the flow of processes goes to step S181.

In step S181, the content managing unit 322 transmits the inquiry result of enabled transmission to the user recording and reproducing system 261-1.

In step S182, the content managing unit 322 receives the similar content 302 from the user recording and reproducing system 261-2 and transmits the received similar content to the user recording and reproducing system 261-1.

Accordingly, the content managing procedure for reproduction is ended.

When the compressed and encoded deleted content 301 is searched for in step S173 of FIG. 19 and the compressed and encoded deleted content 301 is transmitted to the user recording and reproducing system 261-1 in step S174, the following process is performed in step S145 of FIG. 18.

In step S145 of FIG. 18, the recording and reproduction control unit 231 determines whether the compressed and encoded deleted content 301 is received.

In this case, since the compressed and encoded deleted content 301 is transmitted in step S174 of FIG. 19, the determination result of step S145 is YES and the flow of processes goes to step S146. That is, when the compressed and encoded deleted content 301 is transmitted in step S174 of FIG. 19, the recording and reproduction control unit 231 receives the compressed and encoded deleted content 301 and records the received content on the recording medium 71.

In step S146, the recording and reproduction control unit 231 reproduces the compressed and encoded deleted content 301. That is, the recording and reproduction control unit 231 decompresses, decodes, and reproduces the compressed and encoded deleted content 301 recorded on the recording medium 71. Accordingly, the content reproducing procedure is ended.

On the contrary, when the compressed and encoded deleted content 301 is not searched for in step S173 of FIG. 19, the compressed and encoded deleted content 301 is not transmitted to the user recording and reproducing system 261-1. Accordingly, the determination result of step S145 of FIG. 18 is NO and the flow of processes goes to step S147.

In step S147, the recording and reproduction control unit 231 determines whether the information of presence of similar content is received.

When the information of the recording and reproducing apparatus having similar content is not searched for in step S176 of FIG. 19 and the information of absence of similar content is transmitted in step S177, the determination result of step S147 of FIG. 18 is NO and the flow of processes goes to step S150. The process of step S150 and the subsequent processes thereof will be described later.

On the contrary, when the information of the recording and reproducing apparatus 281-2 having the similar content 302 is searched for in step S176 of FIG. 19 and the information of presence of similar content is transmitted in step S178, the determination result of step S147 of FIG. 18 is YES and the flow of processes goes to step S148.

In step S148, the recording and reproduction control unit 231 determines whether the inquiry result of enabled transmission is received.

When the inquiry result of enabled transmission is not received in step S180 of FIG. 19 and the inquiry result of disabled transmission is transmitted in step S183, the determination result of step S148 of FIG. 18 is NO and the flow of processes goes to step S150. The process of step S150 and the subsequent processes thereof will be described later.

On the contrary, when the inquiry result of enabled transmission is received in step S180 of FIG. 19 and the inquiry result of enabled transmission is transmitted in step S181, the determination result of step S148 of FIG. 18 is YES and the flow of processes goes to step S149.

In step S149, the recording and reproduction control unit 231 receives and reproduces the similar content 302. That is, the recording and reproduction control unit 231 receives and reproduces the similar content 302 transmitted in step S182 of FIG. 19. Accordingly, the content reproducing procedure is ended.

On the other hand, when it is determined in step S147 that the information of presence of similar content is not received or when it is determined in step S148 that the inquiry result of enabled transmission is not received, the flow of processes goes to step S150.

In step S150, the recording and reproduction control unit 231 reads the feature quantity of a predetermined scene of the deleted content 301. That is, the recording and reproduction control unit 231 reads the feature quantity of a predetermined scene of the content 301 recorded on the recording medium 71 through the content deleting procedure of FIG. 16.

In step S151, the search unit 232 searches for a similar scene of the predetermined scene of the content 301. That is, the search unit 232 searches the scenes included in plural contents recorded in plural servers 262 for a similar scene via the Internet 271 on the basis of a predetermined allowable similarity.

When a similar scene of the predetermined scene of the content 301 is searched for, the flow of processes goes to step S152. The process of step S152 and the subsequent processes thereof, that is, the processes of steps S152 to S160, are the same as the processes of steps S75 to S83 shown in FIG. 12 and thus description thereof is not repeated.

In step S160, when content including plural scenes recorded on the recording medium 71 is synthesized and reproduced as the search result of steps S151 to S159, the content reproducing procedure is ended.

That is, when the compressed and encoded deleted content 301 is not recorded in the server 262 and the similar content 302 of the deleted content 301 is not recorded in a different user recording and reproducing system 261, the user recording and reproducing system 261-1 searches the other plural servers 162 for a similar scene for each scene included in the content 301. The user recording and reproducing system 261-1 searches for the similar scenes recorded in the other plural servers 162, synthesizes content including the similar scenes, and reproduces the resultant as the similar content of the deleted content 301.

As described above, in the content managing system 251, plural contents are distributed and recorded in plural user recording and reproducing systems 261. Accordingly, it is not necessary for the server 262 to record a large number of contents. Since the user recording and reproducing systems 261 instead of the server 262 may transmit content, the server 262 does not have to respond to all of a large number of requests for transmission. Therefore, it is possible to suppress the construction cost and the operating cost of the server 262.

When similar content is not recorded in the server 262 and the other user recording and reproducing systems 261, the user recording and reproducing system 261-1 can search the other plural servers 162 for content having a high similarity to the deleted content 301 and can reproduce the searched-for content.

### [Application of Present Disclosure to Program]

The above-mentioned series of processes maybe performed by hardware or may be performed by software.

When the series of processes is performed by software, a program constituting the software is installed in a computer mounted on dedicated hardware, a general-purpose personal computer that can perform various functions by installing various programs therein, or the like from a network or a recording medium.

A recording medium having such a program recorded thereon may be constructed by a removable medium (package medium) 70 such as a magnetic disk (including a floppy disk), an optical disc (including a CD-ROM (Compact-Disk-Read Only Memory) and a DVD (Digital Versatile Disk)), a magneto-optical disk (including an MD (Mini-Disk)), or a semiconductor memory, which is distributed to provide a program to a user, independently of the apparatus body, as shown in FIG. 3, or may be constructed by a memory 68 having a program recorded thereon or a hard disk included in a recording medium 71, which is provided to a user in a state where it is previously mounted on the apparatus body.

In this specification, steps describing a program to be recorded on a recording medium include processes performed in parallel or individually without being necessarily performed in time series in addition to processes performed in time series in accordance with the order.

Preferred embodiments of the present disclosure are not limited to the above-mentioned embodiments, but may be modified in various forms without departing from the concept of the present disclosure.

The present disclosure may be implemented as the following configurations.

(1) An information processing apparatus including a recording and reproduction control unit that records content on a predetermined recording medium and that reads and reproduces content from the predetermined recording medium,

wherein the recording and reproduction control unit transmits and records information necessary for reproducing deleted content to a different information processing apparatus when it is intended to delete the content as a deletion target recorded on the predetermined recording medium, and synthesizes and reproduces the deleted content on the basis of the information from the different information processing apparatus when it is instructed to reproduce the deleted content.

(2) The information processing apparatus according to (1), wherein the recording and reproduction control unit performs a compressing and encoding process on the content as a deletion target, transmits and records the resultant compressed and encoded content to the different information processing apparatus, and reads, decompresses, decodes, and reproduces the content as a deletion target recorded in the different information processing apparatus in the form of a compressed and encoded content when it is instructed to reproduce the deleted content.

(3) The information processing apparatus according to (1) or (2), further including a climax characteristic calculating unit that calculates a value of a climax characteristic representing a degree of climax of the details of the content as a deletion target in time series,

wherein the recording and reproduction control unit performs the compressing and encoding process on only a section in which the value of the climax characteristic calculated by the climax characteristic calculating unit is equal to or less than a predetermined threshold value in the content as a deletion target.

(4) The information processing apparatus according to any one of (1) to (3), further including a search unit that searches plural contents recorded in the different information processing apparatus for content identical or similar to the deleted content,

wherein the recording and reproduction control unit records meta data allowing identification of details of the content as a deletion target on the predetermined recording medium,

wherein the search unit searches plural contents recorded in the different information processing apparatus for content identical or similar to the deleted content on the basis of the meta data recorded on the predetermined recording medium by the recording and reproduction control unit, and

wherein the recording and reproduction control unit reads and reproduces the content identical or similar to the deleted content and searched for by the search unit from the different information processing apparatus.

(5) The information processing apparatus according to anyone of (1) to (4), wherein the meta data is a feature quantity of each of plural scenes included in the content, and

wherein the search unit searches the scenes of the plural contents recorded in the different information processing apparatus for a scene having a feature quantity identical or similar to the feature quantity of each of the plural scenes included in the deleted content.

(6) The information processing apparatus according to any one of (1) to (5), wherein the search unit sets a similar range of the feature quantity of each of the plural scenes included in the deleted content on the basis of a predetermined allowable similarity.

(7) The information processing apparatus according to any one of (1) to (6), further including a display control unit that displays a warning for the scene searched for by the search unit after the allowable similarity is lowered by the search unit.

(8) The information processing apparatus according to any one of (1) to (7), wherein the recording and reproduction control unit:

transmits meta data allowing identification of details of the content as a deletion target to the different information processing apparatus;

receives a detection result whether a further different information processing apparatus having content identical or similar to the selected content is present from the different information processing apparatus;

records the meta data on the predetermined recording medium and deletes the content as a deletion target when the detection result that the further different information processing apparatus having content identical or similar to the selected content is present is received;

records the meta data on the predetermined recording medium, performs a compressing and encoding process on the content as a deletion target, transmits the resultant compressed and encoded data to the different information processing apparatus, and deletes the content as a deletion target, when the detection result that the further different information processing apparatus having content identical or similar to the selected content is not present is received;

transmits the meta data to the different information processing apparatus when it is instructed to reproduce the deleted content;

receives the compressed and encoded data when the compressed and encoded data is transmitted from the different information processing apparatus; and

receives the content from the information processing apparatus when the content identical or similar to the deleted content is read and transmitted from the further different information processing apparatus.

(9) The information processing apparatus according to anyone of (1) to (8), wherein the meta data is a feature quantity of the content as a deletion target.

(10) The information processing apparatus according to any one of (1) to (9), wherein the recording and reproduction control unit selects content satisfying a predetermined determination criterion as the content as a deletion target when the data capacity of new content which it is instructed to record on the predetermined recording medium is larger than a predetermined value based on free capacity of the predetermined recording medium.

(11) The information processing apparatus according to anyone of (1) to (10), wherein the predetermined determination criterion is set to a criterion that a user's access frequency is low.

(12) The information processing apparatus according to anyone of (1) to (11), wherein the predetermined determination criterion is set to a criterion that user's operation details on an input unit are an instruction to delete predetermined content.

(13) An information processing apparatus including: a meta data managing unit that detects whether a second different information processing apparatus having content identical or similar to content as a deletion target is present on the basis of meta data allowing identification of details of the content as a deletion target received from a first different information processing apparatus when the first different information processing apparatus deletes the content as a deletion target, that records information of the second different information processing apparatus and the meta data of content identical or similar to the content as a deletion target and transmits a detection result that the second different information processing apparatus is present to the first different information processing apparatus when the second different information processing apparatus is present, and that transmits the detection result that the second different information processing apparatus is not present to the first different information processing apparatus, receives compressed and encoded data obtained by performing a compressing and encoding process on the content as a deletion target from the first different information processing apparatus, and records the received compressed and encoded data on a recording medium, when the second different information processing apparatus is not present; and

a search unit that searches the recording medium for the compressed and encoded data on the basis of the meta data received again from the first different information processing apparatus when the first different information processing apparatus is instructed to reproduce the deleted content, that transmits the compressed and encoded data to the first different information processing apparatus when the compressed and encoded data is present, and that searches for the second different information processing apparatus having content identical or similar to the deleted content when the compressed and encoded data is not present.

(14) The information processing apparatus according to (13), further including content managing unit that inquires the second different information processing apparatus whether to transmit content identical or similar to the deleted content to the first different information processing apparatus when the second different information processing apparatus having content identical or similar to the deleted content is searched for by the search unit, and that reads the content identical or similar to the deleted content from the second different information processing apparatus and transmits the read content to the first different information processing apparatus when the inquiry result of enabled transmission is received from the second different information processing apparatus.

The present disclosure can be applied to recording and reproducing apparatuses connected to a network.

The present disclosure contains subject matter related to that disclosed in Japanese Priority Patent Application JP 2011-084500 filed in the Japan Patent Office on Apr. 6, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a recording and reproduction control unit that records content on a predetermined recording medium and that reads and reproduces content from the predetermined recording medium,
wherein the recording and reproduction control unit transmits and records information necessary for reproducing deleted content to a different information processing apparatus when it is intended to delete the content as a deletion target recorded on the predetermined recording medium, and synthesizes and reproduces the deleted content on the basis of the information from the different information processing apparatus when it is instructed to reproduce the deleted content.

2. The information processing apparatus according to claim 1, wherein the recording and reproduction control unit performs a compressing and encoding process on the content as a deletion target, transmits and records the resultant compressed and encoded content to the different information processing apparatus, and reads, decompresses, decodes, and reproduces the content as a deletion target recorded in the different information processing apparatus in the form of a compressed and encoded content when it is instructed to reproduce the deleted content.

3. The information processing apparatus according to claim 2, further comprising a climax characteristic calculating unit that calculates a value of a climax characteristic representing a degree of climax of the details of the content as a deletion target in time series,
wherein the recording and reproduction control unit performs the compressing and encoding process on only a section in which the value of the climax characteristic calculated by the climax characteristic calculating unit is equal to or less than a predetermined threshold value in the content as a deletion target.

4. The information processing apparatus according to claim 1, further comprising a search unit that searches a plurality of contents recorded in the different information processing apparatus for content identical or similar to the deleted content,
wherein the recording and reproduction control unit records meta data allowing identification of details of the content as a deletion target on the predetermined recording medium,
wherein the search unit searches a plurality of contents recorded in the different information processing apparatus for content identical or similar to the deleted content on the basis of the meta data recorded on the predetermined recording medium by the recording and reproduction control unit, and
wherein the recording and reproduction control unit reads and reproduces the content identical or similar to the deleted content and searched for by the search unit from the different information processing apparatus.

5. The information processing apparatus according to claim 4, wherein the meta data is a feature quantity of each of a plurality of scenes included in the content, and
wherein the search unit searches the scenes included in the plurality of contents recorded in the different information processing apparatus for a scene having a feature quantity identical or similar to the feature quantity of each of the plurality of scenes included in the deleted content.

6. The information processing apparatus according to claim 5, wherein the search unit sets a similar range of the feature quantity of each of the plurality of scenes of the deleted content on the basis of a predetermined allowable similarity.

7. The information processing apparatus according to claim 6, further comprising a display control unit that displays a warning for the scene searched for by the search unit after the allowable similarity is lowered by the search unit.

8. The information processing apparatus according to claim 1, wherein the recording and reproduction control unit:
transmits meta data allowing identification of details of the content as a deletion target to the different information processing apparatus;
receives a detection result whether a further different information processing apparatus having content identical or similar to the selected content is present from the different information processing apparatus;
records the meta data on the predetermined recording medium and deletes the content as a deletion target when the detection result that the further different information processing apparatus having content identical or similar to the selected content is present is received;
records the meta data on the predetermined recording medium, performs a compressing and encoding process on the content as a deletion target, transmits the resultant compressed and encoded data to the different information processing apparatus, and deletes the content as a deletion target, when the detection result that the further different information processing apparatus having content identical or similar to the selected content is not present is received;
transmits the meta data to the different information processing apparatus when it is instructed to reproduce the deleted content;
receives the compressed and encoded data when the compressed and encoded data is transmitted from the different information processing apparatus; and
receives the content from the information processing apparatus when the content identical or similar to the deleted content is read and transmitted from the further different information processing apparatus.

9. The information processing apparatus according to claim 8, wherein the meta data is a feature quantity of the content as a deletion target.

10. The information processing apparatus according to claim 1, wherein the recording and reproduction control unit selects content satisfying a predetermined determination criterion as the content as a deletion target when the data capacity of new content which it is instructed to record on the predetermined recording medium is larger than a predetermined value based on free capacity of the predetermined recording medium.

11. The information processing apparatus according to claim 10, wherein the predetermined determination criterion is set to a criterion that a user's access frequency is low.

12. The information processing apparatus according to claim 10, wherein the predetermined determination criterion is set to a criterion that user's operation details on an input unit are an instruction to delete predetermined content.

13. An information processing method comprising:
recording content on a predetermined recording medium and reading and reproducing content from the predetermined recording medium,
wherein the recording and reading and reproducing includes transmitting and recording information necessary for reproducing deleted content to a different information processing apparatus when it is intended to delete the content as a deletion target recorded on the predetermined recording medium, and synthesizing and reproducing the deleted content on the basis of the information from the different information processing apparatus when it is instructed to reproduce the deleted content.

14. A program causing a computer to perform a control procedure comprising:
recording content on a predetermined recording medium and reading and reproducing content from the predetermined recording medium,
wherein the recording and reading and reproducing includes transmitting and recording information necessary for reproducing deleted content to a different information processing apparatus when it is intended to delete the content as a deletion target recorded on the predetermined recording medium, and synthesizing and reproducing the deleted content on the basis of the information from the different information processing apparatus when it is instructed to reproduce the deleted content.

15. An information processing apparatus comprising:
a meta data managing unit that detects whether a second different information processing apparatus having content identical or similar to content as a deletion target is present on the basis of meta data allowing identification of details of the content as a deletion target received from a first different information processing apparatus when the first different information processing apparatus deletes the content as a deletion target, that records information of the second different information processing apparatus and the meta data of content identical or similar to the content as a deletion target and transmits a detection result that the second different information processing apparatus is present to the first different information processing apparatus when the second different information processing apparatus is present, and that transmits the detection result that the second different information processing apparatus is not present to the first different information processing apparatus, receives compressed and encoded data obtained by performing a compressing and encoding process on the content as a deletion target from the first different information processing apparatus, and records the received compressed and encoded data on a recording medium, when the second different information processing apparatus is not present; and
a search unit that searches the recording medium for the compressed and encoded data on the basis of the meta data received again from the first different information processing apparatus when the first different information processing apparatus is instructed to reproduce the deleted content, that transmits the compressed and encoded data to the first different information processing apparatus when the compressed and encoded data is present, and that searches for the second different information processing apparatus having content identical or similar to the deleted content when the compressed and encoded data is not present.

16. The information processing apparatus according to claim 15, further comprising:
content managing unit that inquires the second different information processing apparatus whether to transmit content identical or similar to the deleted content to the first different information processing apparatus when the second different information processing apparatus having content identical or similar to the deleted content is searched for by the search unit, and that reads the content identical or similar to the deleted content from the second different information processing apparatus and transmits the read content to the first different information processing apparatus when the inquiry result of enabled transmission is received from the second different information processing apparatus.

17. An information processing method comprising:
detecting whether a second different information processing apparatus having content identical or similar to content as a deletion target is present on the basis of meta data allowing identification of details of the content as a deletion target received from a first different information processing apparatus when the first different information processing apparatus deletes the content as a deletion target, recording information of the second different information processing apparatus and the meta data of content identical or similar to the content as a deletion target and transmitting a detection result that the second different information processing apparatus is present to the first different information processing apparatus when the second different information processing apparatus is present, and transmitting the detection result that the second different information processing apparatus is not present to the first different information processing apparatus, receiving compressed and encoded data obtained by performing a compressing and encoding process on the content as a deletion target from the first different information processing apparatus, and recording the received compressed and encoded data on a recording medium when the second different information processing apparatus is not present; and
searching the recording medium for the compressed and encoded data on the basis of the meta data received again from the first different information processing apparatus when the first different information processing apparatus is instructed to reproduce the deleted content, transmitting the compressed and encoded data to the first different information processing apparatus when the compressed and encoded data is present, and searching for the second different information processing apparatus having content identical or similar to the deleted content when the compressed and encoded data is not present.

18. A program causing a computer to perform a control procedure comprising:
detecting whether a second different information processing apparatus having content identical or similar to content as a deletion target is present on the basis of meta data allowing identification of details of the content as a deletion target received from a first different information processing apparatus when the first different information processing apparatus deletes the content as a deletion target;
recording information of the second different information processing apparatus and the meta data of content identical or similar to the content as a deletion target and transmitting a detection result that the second different information processing apparatus is present to the first different information processing apparatus when the second different information processing apparatus is present;
transmitting the detection result that the second different information processing apparatus is not present to the first different information processing apparatus, receiving compressed and encoded data obtained by performing a compressing and encoding process on the content as a deletion target from the first different information processing apparatus, and recording the received compressed and encoded data on a recording medium when the second different information processing apparatus is not present;
searching the recording medium for the compressed and encoded data on the basis of the meta data received again from the first different information processing apparatus when the first different information processing apparatus is instructed to reproduce the deleted content;
transmitting the compressed and encoded data to the first different information processing apparatus when the compressed and encoded data is present; and
searching for the second different information processing apparatus having content identical or similar to the deleted content when the compressed and encoded data is not present.
